(19) United States
(12) Patent Application Publication
(10) Pub. No.: US 2006/0058480 A1
(43) Pub. Date: Mar. 16, 2006

(54) Polymerizable monomer polymeric compound resin compositions for photoresist and method for producing semiconductor

(75) Inventors: Hiroshi Koyama, Himeji-shi (JP); Kiyoharu Tsutsumi, Himeji-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-shi (JP)

(21) Appl. No.: 10/516,176

(22) PCT Filed: Jun. 9, 2004
(86) PCT No.: PCT/JP04/08399

§ 371 Date: Nov. 30, 2004

(30) Foreign Application Priority Data
Jun. 19, 2003 (JP) 2003-174691

(51) Int. Cl. C08F 214/18

(52) U.S. Cl. 526/242; 526/266

(57) ABSTRACT

A polymerizable monomer of the present invention is represented by the following formula (1); 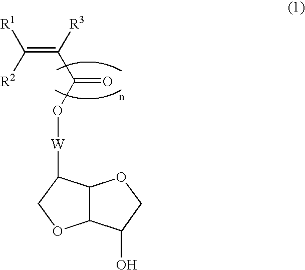
R¹, R² and R³ are each a hydrogen atom, a fluorine atom, an alkyl group or a fluoroalkyl group, W is a single bond or a linkage group and n is 0 or 1, where at least one of R¹, R² and R³ is a fluorine atom or a fluoroalkyl group when n=1; and the ring in the formula may have a substituent. The polymerizable monomer of the present invention can provide an appropriate hydrophilicity or hydrophilicity and transparency to a photoresist polymer.

### TECHNICAL FIELD

The present invention relates to an useful polymerizable monomer as a monomer component of a photoresist resin used for a micro processing of semiconductor and others, a polymeric compound containing a repeated unit corresponding to the monomer, a photoresist resin composition containing the polymeric compound and a process of producing a semiconductor using the resin composition.

### BACKGROUND ART

Resins for photoresist for use in fabricating processes of semiconductors needs a part which exhibits adhesion to substrates such as a silicon wafer and a part which is eliminated by action of an acid generated from a photosensitive acid generator with exposure and become soluble in alkali developer. Further, the photoresist resin also needs to have a resistance to dry etching.

Japanese Unexamined Patent Application Publication No. 2000-26446 discloses an alicyclic hydrocarbon skeleton having a lactone ring as a structure which gives adhesion to substrates and have resistance to dry etching. Further, Japanese Unexamined Patent Application Publication No. 9-73137 suggests an alicyclic hydrocarbon skeleton having a tertiary carbon atom as a structure which gives acid-elimination function and having resistance to dry etching. Therefore, in case that monomers having each of the two skeletons are subjected to co-polymerization, a polymer accumulated necessary functions for a photoresist resin can be obtained. Such co-polymer has adhesion to substrate, acid-elimination function and resistance to dry etching, however, the co-polymer is hard to dissolve in a photoresist solvent and also in an alkali developer after disposure and other problems easily occurs because of very low polarity and low hydrophilicity caused by the co-polymer having an alicyclic hydrocarbon skeleton. Accordingly, a balance of the performance as the resist resin is wrong.

In addition, an exposure-light source of lithography used in semiconductor manufacture becomes shorter wavelength year after year and is converted from KrF excimer laser having a wavelength of 247 nm to ArF excimer laser having a wavelength of 193 nm. F₂ excimer laser having a wavelength of 157 nm is hopefully focused as an exposure-light source of next generation. A conventional resin used in a resist for KrF excimer laser exposure and ArF excimer laser exposure doesn't show sufficient permeability against a vacuum ultraviolet light (a light having a wavelength of 190 nm or low). Some polymeric compounds having a fluorine atom in the molecule has been proposed as a resin with a high permeability against such a vacuum ultraviolet light (for example, Japanese Unexamined Patent Application Publication No. 2002-6501, Japanese Unexamined Patent Application Publication No. 2002-155118, Japanese Unexamined Patent Application Publication No. 2002-179731, Japanese Unexamined Patent Application Publication No. 2002-220419, Japanese Unexamined Patent Application Publication No. 2002-293840, Japanese Unexamined Patent Application Publication No. 2002-327013, Japanese Unexamined Patent Application Publication No. 2003-2925 and so on). However even those resins are not necessarily sufficient for permeability (transparency) against a vacuum ultraviolet light. Further, resins having appropriate such as acid-elimination function, resistance to dry etching, adhesion to substrate and solubility (hydrophilicity) for resist solvent or alkali developer in balance rarely exists.

### DISCLOSURE OF INVENTION

An object of the present invention is to provide a novel polymerizable monomer, which can provide appropriate hydrophilicity, or hydrophilicity and transparency to a photoresist polymer, a polymeric compound having a repeated unit corresponding to the monomer, a photoresist resin composition containing the polymeric compound, and a process for producing a semiconductor using the resin composition.

Another object of the present invention is to provide a novel polymerizable monomer, which can be easily co-polymerized with the other monomer for providing various functions required as a photoresist in addition to be able to provide appropriate hydrophilicity, or hydrophilicity and transparency to a polymer.

A further object of the present invention is to provide a polymeric compound having the properties such as transparency against light used in exposure, appropriate hydrophilicity, acid-eliminating function, resistance to etching and adhesion to substrate in balance, a photoresist resin composition containing the polymeric compound and a process for producing a semiconductor using the resin composition.

Another object of the present invention is to provide a polymeric compound having high transparency against a light having a wavelength of 300 nm or less, particularly a vacuum ultraviolet light, a photoresist resin composition containing the polymeric compound and a process for producing a semiconductor using the resin composition.

An additional object of the present invention is to provide a photoresist resin composition and a process for producing a semiconductor which can accurately form a fine pattern.

The present inventors made intensive investigations to achieve the above objects and found that a novel polymerizable monomer having a 2,6-dioxabicyclo[3.3.0]octane skeleton and found that this monomer can be easily co-polymerized with the other monomer being able to provide various functions required as a photoresist and according to the co-polymerization, a polymeric compound having the properties such as transparency against a light used in exposure, appropriate hydrophilicity, acid-eliminating function, resistance to etching and adhesion to substrate in balance can be produced. The present invention was achieved based on these discoveries.

Namely, the present invention provides a polymerizable monomer represented by the following formula (1); 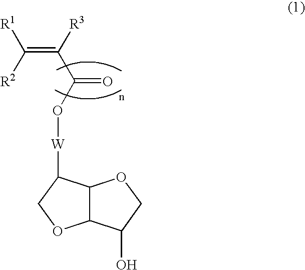
wherein R¹, R² and R³ are each a hydrogen atom, a fluorine atom, an alkyl group or a fluoroalkyl group, W is a single bond or a linkage group and n is 0 or 1, where at least one of R¹, R² and R³ is a fluorine atom or a fluoroalkyl group when n=1; and the ring in the formula may have a substituent.

Preferred polymerizable monomer includes a monomer wherein n is 1, R¹ and R² are a hydrogen atom, and R³ is a trifluoromethyl group, and a monomer wherein n is 0, and R¹, R² and R³ are a hydrogen atom, and others.

Further, the present invention provides a polymeric compound having a repeated unit corresponding to the said polymerizable monomer. The polymeric compound may further include a repeated unit having an acid-eliminating function.

Further, the present invention provides a photoresist resin composition comprising at least the said polymeric compound and a photosensitive acid generator.

In addition, the present invention provides a process of producing a semiconductor, the method comprising the step of applying the photoresist resin composition onto a base or a substrate to form a resist film, exposing, developing and thereby produce a pattern.

Further, in the present description, a vinyl ether monomer and a vinyl ester monomer are defined to include also a compound wherein a hydrogen atom in a vinyl group is substituted for a substituent. In addition, α,β-unsaturated carboxylic acid ester monomer may be named as an acrylic acid ester monomer or an acryl monomer for the sake of convenience. In the present description, “organic group” is used as broad meaning that includes not only a carbon atom containing group but also a group containing a nonmetallic atom such as a halogen atom, a nitro group and a sulfonic acid group.

According to the present invention, a novel polymerizable monomer, which can provide hydrophilicity or hydrophilicity and transparency adequate to a polymer for photoresist. Further, the present invention provides a novel polymerizable monomer, which can provide hydrophilicity, or hydrophilicity and transparency adequate to a polymer and easily co-polymerize with the other monomer for providing various functions required as a photoresist.

A polymeric compound of the present invention can realize appropriate hydrophilicity, or hydrophilicity and transparency required as a photoresist, for example, transparency against a light having a wavelength of 300 nm or less, particularly vacuum ultraviolet light. Further, the properties such as transparency against a light used in exposure, appropriate hydrophilicity, acid-elimination function, resistance to etching, and adhesion to substrate can exhibit in balance. Therefore, a photoresist resin composition containing the said polymeric compound and a process for producing a semiconductor using the resin composition can accurately form a fine pattern.

### BEST MODE FOR CARRYING OUT THE INVENTION

[Polymerizable Monomer]

A polymerizable monomer of the present invention is represented by the above formula (1), which shows a vinyl ether monomer when n is 0, and an acrylic acid ester monomer when n is 1. This monomer provides a polymeric compound by polymerizing at a position of double bond represented in the formula. The monomer has a 2,6-dioxabicyclo[3.3.0]octane skeleton containing two of cyclic ether structures, and the said skeleton has a hydroxyl group, the polymer can be provided hydrophilicity such as solubility against a solvent for resist and an alkali developer, and adhesion to substrate. Further, this monomer is easy to co-polymerize with various monomers used for the properties required as photoresist such as acid-elimination function, adhesion to substrate, transparency, and resistance to etching, for example, a fluorine atom containing acryl monomer and vinyl ether monomer. Therefore, a polymeric compound with excellent for transparency such as vacuum ultraviolet light and also having properties such as acid-elimination function, adhesion to substrate, resistance to etching and hydrophilicity in balance, can be easily prepared. In addition, by using a compound particularly having a fluorine atom in the molecule, for example, a compound where at least one of R¹, R² and R³ is a fluorine atom or a fluoroalkyl group), light transparency of the polymer, particularly, transparency against vacuum ultraviolet light can be improved.

In the formula (1), each of R¹, R² and R³ is a hydrogen atom, a fluorine atom, an alkyl group or a fluoroalkyl group. Provided that at least one of R¹, R² and R³ is a fluorine atom or a fluoroalkyl group when n is 1. As the said alkyl group, there may be mentioned, for example, linear or branched-chain alkyl groups each having about 1 to 15 carbon atoms such as methyl, ethyl, propyl, isopropyl, butyl, isobutyl, s-butyl, t-butyl, pentyl, isopentyl, hexyl, heptyl, octyl, nonyl, decyl and dodecyl.

As the said fluoroalkyl group, there may be mentioned, for example, linear or branched-chain fluoroalkyl groups each having about 1 to 15 carbon atoms such as groups comprising the alkyl group substituted at least a hydrocarbon of the said alkyl group for a fluorine atom. As typical examples of these fluoroalkyl groups, there may be mentioned, for example, trifluoromethyl, pentafluoroethyl, 2,2,2-trifluoroethyl, 2,2,2-trifuluoro-1-(trifluoromethyl)ethyl, heptafluoropropyl, 2,2,3,3,3-pentafluoropropyl, 2,2,3,3-tetrafluoropropyl, nonafluorobutyl, tridecafluorohexyl, henicosafluorodecyl group and so on. Further, in the present description, an alkyl group and a fluoroalkyl group may be described as “an alkyl group which may be fluorinated” together.

Each of R¹ and R² is preferably a hydrogen atom, an alkyl group each having 1 to 3 carbon atoms, or fluoroalkyl groups each having 1 to 3 carbon atoms, among them a hydrogen atom is preferred. R³ is preferably a hydrogen atom, a fluorine atom, alkyl groups each having 1 to 3 carbon atoms or fluoroalkyl groups each having 1 to 3 carbon atoms. R³ is more preferably a hydrogen atom when n is 0, and R³ is more preferably a fluorine atom or fluoroalkyl groups each having 1 to 3 carbon atoms, particularly a trifluoromethyl group when n is 0.

W is a single bond or a linking group. As a linking group, there may be mentioned, for example, bivalent hydrocarbon groups which may have a substituent, a ether bond (an oxygen atom), a thioether bond (a sulfur atom), a carbonyl group, a thiocarbonyl group, —NH— group which may be substituted, or a bivalent group combined with plural these groups.

The said bivalent hydrocarbon group includes bivalent aliphatic hydrocarbon groups, bivalent alicyclic hydrocarbon groups, bivalent aromatic hydrocarbon groups and hydrocarbon groups combined with 2 or more of them. These hydrocarbon group may be combined with one or two or more hydrocarbon group such as aliphatic hydrocarbon groups, alicyclic hydrocarbon groups, aromatic hydrocarbon groups or hydrocarbon groups combined with two or more of them. Further, the bivalent hydrocarbon groups also includes hydrocarbon groups each having a substituent. As the substituent, there may be mentioned a group similar to substituents 2,6-dioxabicyclo[3.3.0]octane ring in the formula (1) described herein after may have.

As typical examples of the bivalent hydrocarbon group, there may be mentioned, for example, alkylene groups such as methylene, methylmethylene, ethylmethylene, dimethylmethylene, ethylmethylmethylene, ethylene, propylene, trimethylene and tetramethylene group; alkenylene groups such as propenylene group; cycloalkylene groups such as a 1,3-cyclopentylene, 1,2-cyclohexylene, 1,3-cyclohexylene, 1,4-cyclohexylene group; cycloalkylidene groups such as a cyclopropylene, cyclopentylidene, cyclohexylidene group; arylene groups such as phenylene group; benzylidene group; and groups of these groups having at least one of hydrogen atom these groups substituted for fluorine atom.

As a substituent of —NH— group, there may be mentioned methyl group, an ethyl group and other alkyl groups (C₁ to C₄ alkyl groups and so on), acetyl group and other acyl groups (C₁ to C₆ acyl groups and so on). As a bivalent group combined with plural of bivalent hydrocarbon groups and others, there may be mentioned, for example, groups of a bivalent hydrocarbon group combined with oxygen atom, groups of two or more bivalent hydrocarbon groups combined via an oxygen atom, ester group, amide group and others.

In the formula (1), a ring in the formula (2,6-dioxabicyclo[3.3.0]octane ring) may have a substituent. As the substituent, there may be mentioned, for example, a halogen atom, an alkyl group, a haloalkyl group, an aryl group, a hydroxyl group which may be protected by a protecting group, a hydroxy(halo)alkyl group which may be protected by a protecting group, an amino group which may be protected by a protecting group, a carboxyl group which may be protected by a protecting group, a sulfo group which may be protected by a protecting group, an oxo group, a nitro group, a cyano group, an acyl group which may be protected by a protecting group and others.

As the said halogen atom, there may be mentioned, for example, a fluorine, a chlorine, a bromine atom and others. As the alkyl group, there may be mentioned, for example, methyl, ethyl, propyl, isopropyl, butyl, isobutyl, s-butyl, t-butyl, hexyl, octyl, decyl and other C₁ to C₁₀ alkyl group, preferably a C₁ to C₅ alkyl group. As the haloalkyl group, there may be mentioned, for example, chloromethyl, trifluoromethyl, 2,2,2-trifluoroethyl and pentafluoroethyl, and other C₁ to C₁₀ haloalkyl group, preferably C₁ to C₅ haloalkyl group. As the aryl group, there may be mentioned, for example, phenyl, naphthyl and others. An aromatic ring of the aryl group may have a substituent such as, for example, a halogen atom such as a fluorine atom, a C₁ to C₄ alkyl group such as a methyl group, a C₁ to C₅ haloalkyl group such as a trifluoromethyl group, a hydroxyl group, a C₁ to C₄ alkoxy group such as a methoxy group, an amino group, a dialkylamino group, a carboxyl group, an alkoxycarbonyl group such as a methoxycarbonyl group, a nitro group, a cyano group, an acyl group such as an acetyl group. As the hydroxy(halo)alkyl group, there may be mentioned, for example, hydroxymethyl, hydroxyethyl, hydroxypropyl, 1-hydroxy-1-methylethyl group, 2,2,2-trifluoro-1-trifluoromethyl-1-hydroxyethyl group and others [preferably a hydroxy-C₁ to C₄ alkyl group, a hydroxy-C₁ to C₄ haloalkyl group and others].

As a protecting group of hydroxyl group in the said hydroxyl group and hydroxy (halo) alkyl group, protecting groups commonly used in the field of organic synthesis, for example, an alkyl group (for example, methyl, t-butyl, and other C₁ to C₄ alkyl group), an alkenyl group (for example, an aryl group), a cycloalkyl group (for example, cyclohexyl group), an aryl group (for example, 2,4-dinitrophenyl group), an aralkyl group (for example, benzyl group); a substituted methyl group (for example, methoxymethyl, methylthiomethyl, benzyloxymethyl, t-butoxymethyl, 2-methoxyethoxymethyl group), a substituted ethyl group (for example, 1-ethoxyethyl group), tetrahydropyranyl group, tetrahydrofuranyl group, 1-hydroxyalkyl group (for example, 1-hydroxyethyl group) and other groups which can form acetal or hemi-acetal group with a hydroxyl group; an acyl group (for example, formyl, acetyl, propionyl, butyryl, isobutyryl, pivaloyl, and other C₁ to C₆ aliphatic acyl group; an acetoacetyl group; benzoyl, and other aromatic acyl group), an alkoxycarbonyl group (for example, a methoxycarbonyl group, and other C₁ to C₄ alkoxy-carbonyl groups), an aralkyloxycarbonyl group, a substituted or unsubstituted carbamoyl group, a substituted silyl group (for example, a trimethylsilyl group and others), and a bivalent hydrocarbon group which may have a substituent (for example, methylene, ethylidene, isopropylidene, cyclopentylidene, cyclohexylidene, benzylidene and other groups) when two or more hydroxyl groups (including a hydroxymethyl group) exist in the molecule can be exemplified.

As the said protecting group of an amino group, there may be mentioned, for example, an alkyl group, an aralkyl group, an acyl group, an alkoxycarbonyl group exemplified as the said protecting group of a hydroxyl group and others. Further, as the protecting group of carboxyl group and sulfo group, there may be mentioned, for example, an alkoxy group (for example, methoxy, ethoxy, butoxy, and other C₁ to C₆ alkoxy groups), a cycloalkyloxy group, an aryloxy group, an aralkyloxy group, a trialkylsilyloxy group, an amino group which may have a substituent, a hydrazino group, an alkoxycarbonylhydrazino group, an aralkylcarbonylhydrazino and others.

As the said acyl group, there may be mentioned, for example, a C₁ to C₆ aliphatic acyl group such as formyl, acetyl, propionyl, butyryl, isobutyryl and pivaloyl group; an acetoacetyl group; an aromatic acyl group such as a benzoyl group; and others. As the protecting group of an acyl group, protecting groups commonly used in the organic synthesis field can be used. As a form of the protected acyl group, there may be mentioned, for example, an acetal (including a hemi-acetal) and others.

Among the above substituents, a fluorine atom, a fluoroalkyl group (for example, trifluoromethyl, 2,2,2-trifluoroethyl, pentafluoroethyl, and other C₁ to C₁₀ fluoroalkyl groups, particularly C₁ to C₅ fluoroalkyl groups), an alkyl group (for example, methyl, ethyl, propyl, isopropyl, butyl, and other C₁ to C₁₀ alkyl groups) and others are preferred. The number of substituents of the said ring is about 0 to 5, preferably about 0 to 3.

As typical examples of the polymerizable monomer represented by the formula (1), there may be mentioned following compounds. As a compound where n=1, there may be mentioned, for example, 1,4:3,6-dianhydro-D-glucitol 2(or 5)-(2-trifluoromethyl-2-propenoate), 1,4:3,6-dianhydro-D-glucitol 2 (or 5)-(2-fluoro-2-propenoate), 1,4:3,6-dianhydro-L-glucitol 2(or 5)-(2-trifluoromethyl-2-propenoate), 1,4:3,6-dianhydro-L-glucitol 2 (or 5)-(2-fluoro-2-propenoate), 1,4:3,6-dianhydro-D-mannitol 2(or 5)-(2-trifluoromethyl-2-propenoate), 1,4:3,6-dianhydro-D-mannitol 2 (or 5)-(2-fluoro-2-propenoate), 1,4:3,6-dianhydro-L-mannitol 2(or 5)-(2-trifluoromethyl-2-propenoate), 1,4:3,6-dianhydro-L-mannitol 2 (or 5)-(2-fluoro-2-propenoate), 1,4:3,6-dianhydro-D-idytol 2(or 5)-(2-trifluoromethyl-2-propenoate), 1,4:3,6-dianhydro-D-idytol 2(or 5)-(2-fluoro-2-propenoate), 1,4:3,6-dianhydro-L-idytol 2(or 5)-(2-trifluoromethyl-2-propenoate), 1,4:3,6-dianhydro-L-idytol 2(or 5)-(2-fluoro-2-propenoate) and others.

As a compound when n=0, there may be mentioned, for example, 1,4:3,6-dianhydro-D-glucitol 2(or 5)-vinyl ether, 1,4:3,6-dianhydro-L-glucitol 2(or 5)-vinyl ether, 1,4:3,6-dianhydro-D-mannitol monovinyl ether, 1,4:3,6-dianhydro-L-mannitol monovinyl ether, 1,4:3,6-dianhydro-D-idytol monovinyl ether, 1,4:3,6-dianhydro-L-idytol monovinyl ether and others.

Among the polymerizable monomers represented by the above formula (1), a compound wherein n=1 can be yielded, for example, by allowing an unsaturated carboxylic acid or a reactive derivative thereof (an acid halide, an acid anhydride, an ester and others) represented by the following formula (2); 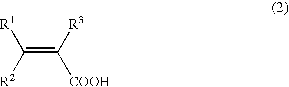
wherein R¹, R² and R³ are the same meanings as defined above, to react with a hydroxy compound [3,6-dianhydrohexytol (a 1,4;3,6-dianhydro formed of sugar alcohol having 6 carbon atoms) (for example, isosorbide, isomannide and others) and others] represented by the following formula (3); 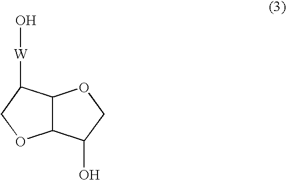
wherein W is the same meanings as described above, and the ring in the formula may have a substituent.

In this reaction, as a catalyst, sulfuric acid, hydrochloric acid or p-toluene sulfonic acid is used when the unsaturated carboxylic acid represented by formula (2) are used in the reaction as one raw material. Reactions are usually performed in the presence of a salt such as triethyl amine, pyridine, sodium hydroxide and sodium carbonate when an acid halide or anhydride of the unsaturated carboxylic acid represented by the formula (2) is used in the reaction. Further, an ester exchange catalyst is preferably used as a catalyst when an ester of the unsaturated carboxylic acid represented by the formula (2) is used in the reaction. As the ester exchange catalyst, compounds commonly used in the organic synthesis field can be used. The amount of the unsaturated carboxylic acid or the reactive derivative thereof represented by the formula (2) is usually from about 0.9 to 1.3 moles, relative to 1 mole of the hydroxy compound represented by the formula (3). The reaction may be performed in a appropriate solvent (for example, toluene and others). The reaction can appropriately be selected depending on the raw material. used therein and is, for example, from about −10° C. to 150° C. The reaction product can be separated and purified by separation means such as filtration, concentration, distillation, extraction, crystallization, recrystallization and column chromatography.

Among the polymerizable monomer represented by the above formula (1), a compound where n=0 can be obtained, for example, by allowing a vinyl ester compound represented by the following formula (4); 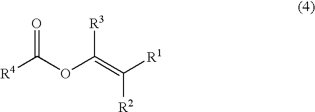
wherein R⁴ is a hydrogen atom, an alkyl group or a phenyl group, R¹, R² and R³ are the same meanings as described above, to react with a hydroxy compound represented by the above formula (3) under an iridium compound catalyst.

As an alkyl group in R⁴ of the formula (4), there may be mentioned, for example, an alkyl group of about 1 to 10 carbon atoms such as methyl, ethyl, propyl, butyl, isobutyl, s-butyl, t-butyl and hexyl group. As R⁴, an alkyl group of 1 to 3 carbon atoms such as methyl group and a phenyl group are particularly preferred.

The iridium catalyst is not particularly limited but an iridium complex is preferable, particularly an organic iridium complex having an unsaturated hydrocarbon such as cyclopentene, dicyclopentadiene, cyclooctene, 1,5-cyclooctadiene, ethylene, pentamethyl cyclopentadiene, benzene and toluene; a nitrile such as acetonitrile; an ether such as tetrahydrofuran; or others as a ligand. Typical examples of the organic iridium catalyst include di-μ-chlorotetraxis(cyclooctene) II iridium (I), di-μ-chlorotetraxis(ethylene) II iridium (I), di-μ-chloro bis(1,5-cyclooctadiene) II iridium (I), bis(1,5-cyclooctadiene)iridium tetrafluoroborate, (1,5-cyclooctadiene)(acetonitrile)iridium tetrafluoroborate and others. The amount of an iridium compound catalyst is, for example, 0.0001 to 1 mole, preferably about 0.001 to 0.3 moles, relative to 1 mole of the hydroxy compound represented by the formula (3).

The reaction in the presence of, or in the absence of, a solvent. As a solvent, there may be mentioned, for example, an aliphatic hydrocarbon such as hexane, an alicyclic hydrocarbon such as cyclohexane, an aromatic hydrocarbon such as toluene, a halogenated hydrocarbon such as dichloromethane, a linear or cyclic ether such as tetrahydrofuran, an ester such as ethyl acetate, a ketone such as acetone, an amide such as N,N-dimethylformamide, a nitrile such as acetonitrile, and others. The amount of a vinyl ester compound represented by the formula (4) is, for example, from about 0.9 to about 1.3 moles, relative to 1 mole of the hydroxy compound represented by the formula (3).

In the above reaction, a reaction rate is extremely increased in the presence of a salt in the reaction system. Such salts include an inorganic salt and an organic salt. As an inorganic salt, there may be mentioned, for example, an alkali metal hydroxide such as sodium hydroxide, an alkali earth metal hydroxide such as magnesium hydroxide, an alkali metal carbonate salt such as sodium carbonate, an alkali earth metal carbonate salt such as magnesium carbonate, an alkali metal hydrogencarbonate salt such as sodium hydrogencarbonate, and others. As the organic salt, there may be mentioned, for example, an alkali metal organic acid salt such as sodium acetate, an alkali metal alkoxide such as sodium methoxide, a tertiary amine such as triethyl amine, a nitrogen-containing aromatic heterocyclic compound such as pyridine, and others. The amount of salt is, for example, from 0.001 to 3 moles, preferably from about 0.005 to 2 moles, relative to 1 mole of the hydroxy compound represented by the formula (3).

The reaction may be performed in the presence of a polymerization-inhibitor. The reaction temperature can be appropriately selected depending on the kind of reaction component and is, for example, from about 50 to 150° C. The reaction product can be separated and purified by separation means such as filtration, concentration, distillation, extraction, crystallization, recrystallization and column chromatography.

[Polymeric Compound]

A polymeric compound of the present invention contains a repeated unit (monomer unit) corresponding to a polymerizable monomer of the present invention described above. Such repeated unit may be either one sort or two or more sorts. These polymeric compounds can be obtained by subjecting the above polymerizable monomer to polymerization.

In order to have various functions required as resist in balance, the polymeric compound of the present invention may have other repeated unit in addition to the repeated unit corresponding to the polymerizable monomer of the present invention described above. These other repeated unit can be produced by allowing a polymerizable unsaturated monomer corresponding to the said repeated unit to co-polymerize with the polymerizable monomer of the present invention. As the above other repeated unit, there may be mentioned, for example, a repeated unit enhancing adhesion to substrate and/or hydrophilic function, a repeated unit having acid-eliminating function, a repeated unit having resistance to etching function, a repeated unit improving transparency, and others. Further, in case of preparation of the polymeric compound of the present invention, monomers used for the polymerization to be proceeded smoothly and/or the co-polymer composition to be balanced can be used as a co-monomer.

A repeated unit enhancing adhesion to substrate or hydrophilic function can be introduced to a polymer when a polymerizable unsaturated monomer having a polar group is used as a co-monomer. As the said polar group, there may be mentioned, for example, a hydroxyl group which may have a protecting group, a carboxyl group which may have a protecting group, an amino group which may have a protecting group, a sulfo group which may have a protecting group, a group having a lactone ring, and others. As the said protecting group, one commonly used in the organic synthesis field (for example, a protecting group exemplified as described above) can be used. As a polymerizable unsaturated monomer having a polar group, a conventional compound in the resist field can be applied.

A repeated unit having acid-eliminating function can be introduced to a polymer by using, for example, (1) a (meth)acrylic acid ester derivative in which a hydrocarbon having a tertiary carbon, a 2-tetrahydrofuranyl group, a 2-tetrahydropyranyl group or others are combined at the adjacent position of oxygen atom constituting the ester, (2) a (meth) acrylic acid ester derivative which have a hydrocarbon group (an alicyclic hydrocarbon group, an aliphatic hydrocarbon group, a group bonded by these groups, and others) at the adjacent position of oxygen atom constituting the ester, and the hydrocarbon group is combined with —COOR group, wherein R is a tertiary hydrocarbon group, a 2-tetrahydrofuranyl group, a 2-tetrahydropyranyl group or others, directly or via linkage group as a co-monomer. In addition, a carbon atom at the adjacent position of a tertiary carbon of tertiary hydrocarbon group in the said R needs to be combined with at least a hydrogen atom. As such a (meth)acrylic acid eater derivative, conventional compounds in the resist field can be used.

As typical examples of a polymerizable unsaturated monomer used to provide various functions as resist for a polymeric compound of the present invention except for a monomer of the present invention, there may be mentioned a vinyl ether monomer represented by the following formula (5a) or (5b); 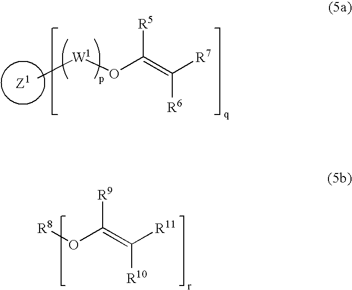
wherein, in the formula (5a), a ring Z¹ is one of rings represented by the following formula (6a), (6b), (6c), (6d), (6e), (6f), (6g) or (6h); 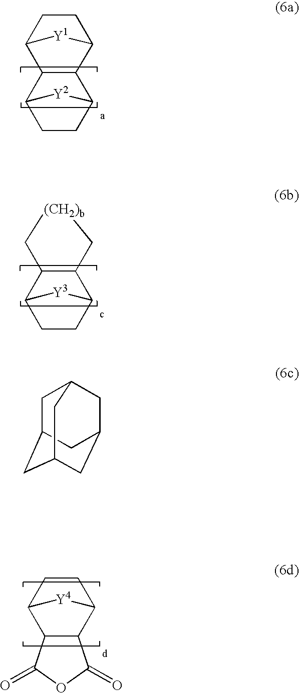 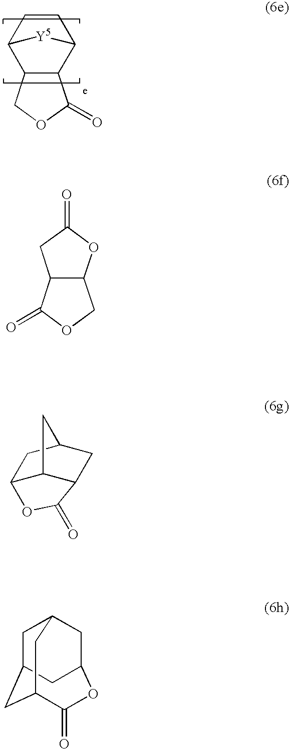
wherein Y¹ is an alkylene group, an oxygen atom or a sulfur atom, Y², Y³, Y⁴ and Y⁵ are each an alkylene group, an oxygen atom, a sulfur atom or non-bonding, a, c, d and e are each an integer of 0 to 3, b is 1 or 2, and the ring in the formulae may have a substituent;
W¹ is a bivalent hydrocarbon group. R⁵, R⁶ and R⁷ is identical to or different from a hydrogen atom or an organic group. At least two of the ring Z¹, W¹, R⁵, R⁶ and R⁷ may be combined with each other to form a ring together with the adjacent one or two or more atoms. p is 0 or 1, q denotes an integer of from 1 to 8. Each of q groups in brackets may be the same or different when q is 2 or more. In the formula (5b), R⁸ is an alkyl group which may have a substituent, R⁹, R¹⁰ and R¹¹ may be identical to or different form a hydrogen atom or an organic group. At least two of R⁸, R⁹, R¹⁰ and R¹¹ may be combined with each other to form a ring with adjacent one or two or more atoms. r denotes an integer of from 1 to 8. Each of r groups in brackets may be the same or different when r is 2 or more.

By co-polymerizing such a vinyl ether monomer, particularly a vinyl ether monomer having an alicyclic hydrocarbon ring, the resistance to etching of a polymer can be improved. Further, by applying a vinyl ether compound having a polar group in the molecule, the adhesion to substrate and/or the hydrophilicity can be advanced. These vinyl ether compounds can be used by one or two or more combination.

As an alkylene group of the said Y¹, Y², Y³, Y⁴ and Y⁵, there may be mentioned, for example, methylene, ethylene, propylene, trimethylene group and other linear or branched-chain alkylene groups having from about 1 to about 3 (preferably 1 or 2) carbon atoms. As a substituent a ring in the formulae (6a) to (6h) may have, there may be mentioned the same substituent as a group the ring in the said formula (1) may have. As a preferable substituent, there may be mentioned, for example, a fluorine atom, a fluoroalkyl group (for example, trifluoromethyl, 2,2,2-trifluoroethyl, pentafluoroethyl, and other C₁-C₁₀ fluoroalkyl groups, particularly C₁-C₅ fluoroalkyl group and others), an alkyl group (for example, methyl, ethyl, propyl, isopropyl, butyl group, and other C₁-C₁₀ alkyl groups, particularly C₁-C₅ alkyl groups) and others. The number of substituents in each rings is from about 0 to about 5, preferably from about 0 to about 3. When the number of substituents of ring is 2 or more, they may be combined with each other to form a 4 or more membered ring, for example, a cycloalkane ring, a lactone ring and others with a carbon atom constituting the ring.

W¹ is a bivalent hydrocarbon group. The bivalent hydrocarbon group includes a bivalent aliphatic hydrocarbon group, a bivalent alicyclic hydrocarbon group, a bivalent aromatic hydrocarbon group and a hydrocarbon group combined together with two or more of them. These hydrocarbon groups may be bonded by one or two or more univalent hydrocarbon groups (an aliphatic hydrocarbon group, an alicyclic hydrocarbon group, an aromatic hydrocarbon group and a hydrocarbon group combined with two or more of them). In addition, the bivalent hydrocarbon group includes a hydrocarbon group having a substituent. The said substituent may have, for example, a halogen atom (a fluorine atom and soon), an oxo group, a hydroxyl group, a substituted oxy group (for example, an alkoxy group, an aryloxy group, an aralkyloxy group, an acyloxy group and so on), a carboxyl group, a substituted oxycarbonyl group (an alkoxycarbonyl group, an aryloxycarbonyl group, an aralkyloxycarbonyl group and so on), a substituted or unsubstituted carbamoyl group, a cyano group, a nitro group, a substituted or unsubstituted amino group, a sulfo group, a heterocyclic group and so on. The said hydroxyl group and carboxyl group may be protected by a protecting group which is common in the organic synthesis field. Further, a ring of the alicyclic hydrocarbon group or the aromatic hydrocarbon group may be condensed by an aromatic or non-aromatic hetero ring.

As typical examples of bivalent hydrocarbon group, there may be mentioned, for example, an alkylene group such as a methylene, a methylmethylene, an ethylmethylene, a dimethylmethylene, an ethylmethylmethylene, an ethylene, a propylene, a trimethylene and a tetramethylene group; an alkenylene group such as a propenylene group; a cycloalkylene group such as a 1,3-cyclopentylene, a 1,2-cyclohexylene, a 1,3-cyclohexylene and a 1,4-cyclohexylene; a cycloalkylidene group such as a cyclopropylene, a cyclopentylidene, and a cyclohexylidene group; an arylene group such as a phenylene group; a benzylidene group; and a group substituted at least one of a hydrogen atoms had by these groups by a fluorine atom; and so on.

A preferable example of W¹ includes, for example, a group represented by the following formula (7); 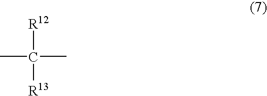
wherein each of R¹² and R¹³ is identical to or different from a hydrogen atom or a hydrocarbon group, R¹² and R¹³ may be combined with each other to form an alicyclic hydrocarbon together with the adjacent carbon atom.

As a hydrocarbon group in R¹² and R¹³, there may be mentioned an aliphatic hydrocarbon group (an alkyl group of from about 1 to about 20 carbon atoms, an alkenyl group of from about 2 to about 20 carbon atoms, an alkynyl group of from about 2 to about 20 carbon atoms and so on), an alicyclic hydrocarbon group (a cycloalkyl group of from about 3 to about 20 members, a cycloalkenyl group of from about 3 to about 20 members, a bridged cyclic hydrocarbon group and so on), an aromatic hydrocarbon group (an aromatic hydrocarbon group of from about 6 to about 14 carbon atoms and so on) and a group combined with two or more them. A hydrocarbon group having a substituent is also includes in the said hydrocarbon group. As the said substituent, there may be mentioned the same as the substituent a bivalent hydrocarbon group in the said W¹ may have.

A preferable R¹² or R¹³ includes a hydrogen atom, a methyl, an ethyl, a propyl, an isopropyl, a butyl group, and other C₁-C₁₀ alkyl groups (particularly, C₁-C₅ alkyl groups); cyclopentyl group, a cyclohexyl group, and other cycloalkyl groups which may have a substituent, a norbornane-2-yl group, an adamantane-1-yl group, and other bridged cyclic groups which may have a substituent; and so on. As a substituent the cycloalkyl group and the bridged cyclic group may have, there may be mentioned the same as the substituent a ring in the said formulae (6a) to (6h) may have.

As an organic group of R⁵, R⁶ and R⁷ in the formula (5a), there may be mentioned, for example, a halogen atom, a hydrocarbon group, a heterocyclic group, a substituted oxycarbonyl group (an alkoxycarbonyl group, an aryloxycarbonyl group, an aralkyloxycarbonyl group, a cycloalkyloxycarbonyl group and so on), a carboxyl group, a substituted or unsubstituted carbamoyl group, a cyano group, a nitro group, a sulfur acid group, a sulfur acid ester group, an acyl group (an aliphatic acyl group such as an acetyl group; an aromatic acyl group such as a benzoyl group; and so on), an alkoxy group (a C₁-C₆ alkoxy group such as a methoxy group and an ethoxy group, and so on), a N,N-di saturated amino group (N,N-dimethyl amino group, piperidino group and so on), a group combined with 2 or more of them and so on, and the said carboxyl group and others may be protected by a protecting group widely known or conventional in the organic synthesis field. As the said halogen atom, there may be mentioned a fluorine, a chlorine, a bromine and an iodine atom. In these organic groups, a hydrocarbon group and a heterocyclic group are preferable.

The said hydrocarbon and heterocyclic group also include a hydrocarbon group and heterocyclic group having a substituent. As the hydrocarbon group, there may be mentioned the same as the said hydrocarbon group in the R¹² and R¹³. A preferable hydrocarbon group includes a C₁-C₁₀ alkyl group, a C₂-C₁₀ alkenyl group, a C₂-C₁₀ alkynyl group, a C₃-C₁₅ cycloalkyl group, a C₆-C₁₀ aromatic hydrocarbon group, a C₃-C₁₅ cycloalkyl-C₁-C₁₄ alkyl group, a C₇-C₁₄ aralkyl group and so on. These hydrocarbon groups may have a substituent and as the said substituent, there may be mentioned the same as the said substituents the bivalent hydrocarbon group in the W¹ may have.

A hetero ring constituting the said heterocyclic group in the R⁵ and others includes an aromatic hetero ring and non-aromatic hetero ring. As such a hetero ring, there may be mentioned, for example, a hetero ring having oxygen atom, sulfur atom or nitrogen atom as a hetero atom and so on. A hetero ring group may have a substituent such as an alkyl group (for example, a C₁-C₄ alkyl group such as a methyl and an ethyl group and so on), a cycloalkyl group and an aryl group (for example, a phenyl, a naphthyl group and so on) in additional to the said substituent the hydrocarbon may have.

As a preferable R⁵, R⁶ and R⁷, a hydrogen atom, a hydrocarbon group (for example, a C₁-C₁₀ alkyl group, a C₂-C₁₀ alkenyl group, a C₂-C₁₀ alkynyl group, a C₃₋₁₅ cycloalkyl group, a C₆-C₁₀ aromatic hydrocarbon group, a C₃-C₁₅ cycloalkyl-C₁-C₄ alkyl group, a C₇-C₁₄ aralkyl group, and so on) and others are included. As a R⁵, R⁶ and R⁷, a hydrocarbon and a C₁₋₃ alkyl group such as a methyl group and so on.

A ring formed by combining at least two of ring Z¹, W¹, R⁵, R⁶ and R⁷ together with the adjacent 1 or 2 or more atoms includes an non-aromatic carbon ring or hetero ring.

Typical examples of vinyl ether compound represented by the formula (5a) includes the following compounds. As a vinyl ether compound in which the ring Z¹ is a group represented by the formula (6a), there may be mentioned, for example, 2-vinyloxynorbornane, 5-methoxycarbonyl-2-vinyloxynorbornane, 2-[1-(norbornane-2-yl)-1-vinyloxyethyl]norbornane, 2-(vinyloxymethyl)norbornane, 2-(1-methyl-1-vinyloxyethyl)norbornane, 2-(1-methyl-1-vinyloxypentyl)norbornane, 3-hydroxy-4-vinyloxytetracyclo[4.4.0.1^{2,5}.1^{7,10}]dodecane, 3-hydroxy-8-vinyloxytetracyclo[4.4.0.1^{2,5}.1^{7,10}]dodecane, 3-methoxycarbonyl-8-vinyloxytetracyclo[4.4.0.1^{2,5}.1^{7,10}]dodecane, 3-methoxycarbonyl-9-vinyloxytetracyclo[4.4.0.1^{2,5}.1^{7,10}]dodecane, 3-(vinyloxymethyl)tetracyclo[4.4.0.1^{2,5}.1^{7,10}]dodecane, 3-hydroxymethyl-8-vinyloxytetracyclo[4.4.0.1^{2,5}.1^{7,10}]dodecane, 3-hydroxymethyl-9-vinyloxytetracyclo[4.4.0.1^{2,5}.1^{7,10}]dodecane, 8-hydroxy-3-(vinyloxymethyl)tetracyclo[4.4.0.1^{2,5}.1^{7,10}]dodecane, 9-hydroxy-3-(vinyloxymethyl)tetracyclo[4.4.0.1^{2,5}.1^{7,10}]dodecane, an isopropenyl ether corresponding to them and so on.

As a vinyl ether compound in which the ring Z¹ is the ring represented by the formula (6b), there may be mentioned, for example, vinyloxy cyclopentane, vinyloxy cyclohexane, cis-1,1,13-trimethyl-5-vinyloxy cyclohexane, trans-1,1,13-trimethyl-5-vinyloxy cyclohexane, 1-isopropyl-4-methyl-2-vinyloxy cyclohexane, 3-vinyloxytricyclo[6.2.1.0.^{2,7}]undecane, 4-vinyloxytricyclo[6.2.1.0.^{2,7}]undecane, 2-vinyloxy-7-oxabicyclo[3.2.1]octane-6-on, (2,2,2-trifluoro-1-trifluoromethyl-1-cyclohexylethyl)vinyl ether, [2,2,2-trifluoro-1-trifluoromethyl-1-(4-trifluoromethylcyclohexyl)ethyl]vinyl ether, (1-trifluoromethyl-1-cyclohexylethyl)vinyl ether, [1-trifluoromethyl-1-(4-trifluoromethylcyclohexyl)ethyl]vinyl ether, an isopropenyl ether corresponding to them and so on.

As a vinyl ether compound in which the ring Z¹ is the ring represented by the formula (6c), there may be mentioned, for example, 1-vinyloxy adamantane, 2-vinyloxy adamantane, 2-methyl-2-vinyloxy adamantane, 2-ethyl-2-vinyloxy adamantane, 1-hydroxy-3-vinyloxy adamantane, 1,3-dihydroxy-5-vinyloxy adamantane, 1,3,5-trihydroxy-7-vinyloxy adamantane, 1,3-dimethyl-5-vinyloxy adamantane, 1-hydroxy-3,5-dimethyl-7-vinyloxy adamantane, 1-carboxy-3-vinyloxy adamantane, 1-amino-3-vinyloxy adamantane, 1-nitro-3-vinyloxy adamantane, 1-sulfo-3-vinyloxy adamantane, 1-t-butyroxycarbonyl-3-vinyloxy adamantane, 4-oxo-1-vinyloxy adamantane, 1-(vinyloxymethyl)adamantane, 1-(1-methyl-1-vinyloxyethyl)adamantane, 1-(1-ethyl-1-vinyloxyethyl)adamantane, 1-(1-(norbornane-2-yl)-1-vinyloxyethyl)adamantane, an isopropenyl ether corresponding to them and so on.

As a vinyl ether compound in which the ring Z¹ is the ring represented by the formula (6d), there may be mentioned, for example, 8-vinyloxy-4-oxatricyclo[5.2.1.0^{2,6}]decane-3,5-dion, 4-vinyloxy-11-oxapentacyclo[6.5.1.1^{3,6}.0^{2,7}.0^{9,13}]pentadecane-10,12-dion, an isopropenyl ether corresponding to them and so on.

As a vinyl ether compound in which the ring Z¹ is the ring represented by the formula (6e), there may be mentioned, for example, α-vinyloxy-γ-butyrolactone, β-vinyloxy-γ-butyrolactone, γ-vinyloxy-γ-butyrolactone, α-vinyloxy-γ,γ-dimethyl-γ-butyrolactone, α,γ,γ-trimethyl-α-vinyloxy-γ-butyrolactone, γ,γ-dimethyl-β-methoxycarbonyl-α-vinyloxy-γ-butyrolactone, 8-vinyloxy-4-oxatricyclo[5.2.1.0^{2,6}]decane-3-on, 9-vinyloxy-4-oxatricyclo[5.2.1.0^{2,6}]decane-3-on, an isopropenyl ether corresponding to them and so on.

As a vinyl ether compound in which the ring Z¹ is the ring represented by the formula (6f), there may be mentioned, for example, 4-vinyloxy-2,7-dioxabicyclo[3.3.0]octane-3,6-dion, an isopropenyl ether corresponding to them and so on.

As a vinyl ether compound in which the ring Z¹ is the ring represented by the formula (6g), there may be mentioned, for example, 5-vinyloxy-3-oxatricyclo[4.2.1.0^{4,8}]nonane-2-on, 5-methyl-5-vinyloxy-3-oxatricyclo[4.2.1.0^{4,8}]nonane-2-on, 9-methyl-5-vinyloxy-3-oxatricyclo[4.2.1.0^{4,8}]nonane-2-on, an isopropenyl ether corresponding to them and so on.

As a vinyl ether compound in which the ring Z¹ is the ring represented by the formula (6h), there may be mentioned, for example, 6-vinyloxy-3-oxatricyclo[4.3.1.1^{4,8}]undecane-2-on, 6-hydroxy-8-vinyloxy-3-oxatricyclo[4.3.1.1^{4,8}]undecane-2-on, 8-hydroxy-6-vinyloxy-3-oxatricyclo[4.3.1.1^{4,8}]undecane-2-on, an isopropenyl ether corresponding to them and so on.

As an alkyl group of R⁸ in the said formula (5b), there may be mentioned a linear or branched-chain alkyl group of 1 to 20 carbon atoms (preferably 1 to 10 carbon atoms) such as a methyl, an ethyl, a propyl, an isopropyl, a butyl, an isobutyl, a s-butyl, a t-butyl, a pentyl, a neopentyl, a hexyl, an octyl, and a decyl group. A substituent the said alkyl group may have include, for example, a halogen atom (a fluorine atom, chlorine atom, bromine atom and so on), an oxo group, a hydroxyl group, a substituted oxy group (for example, an alkoxy group, an aryloxy group, an aralkyloxy group, an acyloxy group and so on), a carboxyl group, a substituted oxycarbonyl group (an alkoxycarbonyl group, an aryloxycarbonyl group, an aralkyloxycarbonyl group and so on), a substituted or non-substituted carbamoyl group, a cyano group, a nitro group, a substituted or non-substituted amino group, a sulfo group, an aromatic hydrocarbon group, a heterocyclic group and so on. The said hydroxyl group and carboxyl group may be protected by a protecting group which is commonly used in the organic synthesis field.

As an organic group in R⁹, R¹⁰ and R¹¹, there may be mentioned the same as an organic group in R⁵, R⁶ and R⁷. Preferable R⁹, R¹⁰ and R¹ include a hydrogen atom, a hydrocarbon group (for example, a C₁-C₁₀ alkyl group, a C₂-C₁₀ alkenyl group, a C₂-C₁₀ alkynyl group, a C₃-C₁₅ cycloalkyl group, a C₆-C₁₀ aromatic hydrocarbon group, a C₃-C₁₂ cycloalkyl-C₁-C₄ alkyl group, a C₇-C₁₄ aralkyl group and so on) and so on. As R⁹, R¹⁰ and R¹¹, a hydrogen atom and a C₁-C₃ alkyl group such as a methyl group are particularly preferable. A ring formed by at least two of the said R⁸, R⁹, R¹⁰ and R¹¹ combined with each other together with the adjacent one or two or more atoms includes non-aromatic carbon ring or hetero ring.

As typical examples of a vinyl ether compound represented by the formula (5b), there may be mentioned, for example, methyl vinyl ether, ethyl vinyl ether, propyl vinyl ether, isopropyl vinyl ether, s-butyl vinyl ether, t-butyl vinyl ether, hexyl vinyl ether, ethylene glycol monovinyl ether, ethylene glycol divinyl ether, trifluoromethyl vinyl ether, (2,2,2-trifluoroethyl)vinyl ether, (2,2,3,3,3-pentafluoropropyl)vinyl ether, (2,2,3,3-tetrafluoropropyl)vinyl ether, (2,2,3,3,4,4,4-pentafluorobutyl)vinyl ether, (2,2,3,3,4,4-hexafluorobutyl)vinyl ether, (2,2,3,3,4,4,5,5,5-nonafluoropentyl)vinyl ether, (2,2,3,3,4,4,5,5-octafluoropentyl)vinyl ether, (2,2,3,3,4,4,5,5,6,6,7,7,7-tridecafluoropentyl)vinyl ether, (2,2,3,3,4,4,5,5,6,6,7,7-dodecafluoropentyl)vinyl ether, (3,3,4,4,5,5,6,6,7,7,8,8,9,9,10,10,10-heptadecafluorodecyl) vinyl ether, (2,2,3,3,4,4,5,5,6,6,7,7,8,8,9,9,10,10,11,11-icosafluoroundecyl)vinyl ether, (2,2,2-trifluoro-1-trifluoromethylethyl)vinyl ether, (1,2,2,2-tetrafluoro-1-trifluoromethylethyl)vinyl ether, [1,1-bis(trifluoromethyl)ethyl]vinyl ether, (1-trifluoromethyl-1-methylethyl)vinyl ether, (2,2,2-trifluoro-1-trifluoromethyl-1-phenylethyl)vinyl ether, (1-trifluoromethyl-1-phenylethyl)vinyl ether, an isopropenyl ether corresponding to them, dihydropyran and so on.

In the said vinyl ether monomer, (1) a compound comprising a compound represented by the formula (5a) where the ring Z¹ is the ring represented by the formula (6d), (6e), (6f), (6g) or (6h), (2) a compound comprising a compound represented by the formula (5a) where the ring Z¹ is the ring represented by the formula (6a), (6b) or (6c), and a ring Z¹ is combined with the said polar group or the group having a polar group, or W¹, R⁵, R⁶ or R⁷ have a group having a polar group, and (3) a compound comprising a compound represented by the formula (5b) where R⁸, R⁹, R¹⁰ or R¹¹ is a group having a polar group, form a repeated unit having adhesion to substrate and/or hydrophilicity by subjecting to co-polymerization as co-monomer.

The said vinyl ether monomer can be produced by a known method or by applying a known reaction. Further, it can be also produced according to the method represented as a production process of a compound comprising a compound represented by the formula (1) where n is 0.

As other typical examples of a polymerizable unsaturated monomer used for providing various functions as resist to the polymer of the present invention except for monomers of the present invention, there may be mentioned an acrylic acid ester monomer represented by the following formula (8a) or (8b); 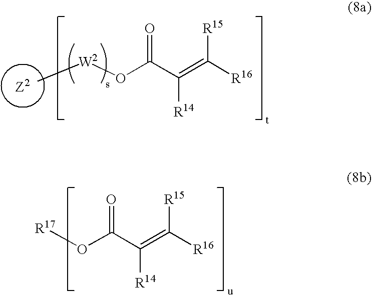
wherein, in the formula (8a), ring Z² is one of rings represented by the said formula (6a), (6b), (6c), (6d), (6e), (6f), (6g) or (6h); and W² is a bivalent hydrocarbon group. The ring in the formula may have a substituent. R¹⁴, R¹⁵ and R¹⁶ are each a hydrogen atom, a fluorine atom, an alkyl group or an fluoroalkyl group. s is 0 or 1 and t denotes an integer of 1 to 8. When t is 2 or more, each groups in the t brackets may be the same or different. In the formula (8b), R¹⁷ is an alkyl group which may have a substituent. R¹⁴, R¹⁵ and R¹⁶ are the same meanings as described above. u denotes an integer of 1 to 8. When u is 2 or more, each groups in the u brackets may be the same or different.

Among the acrylic acid ester monomers, in case of using a compound containing a fluorine atom in the molecule as co-monomer, transparency to light having a wavelength of 300 nm or less, particularly vacuum ultraviolet light, can be improved. In addition, in case of using an acrylic acid ester monomer having an alicyclic hydrocarbon ring, resistance to etching of the polymer can be enhanced. In case of using an acrylic acid ester monomer having a polar group in the molecule, adhesion to substrate and/or hydrophilicity can be improved. Further, in the case of using an acrylic acid ester monomer bonded to oxygen atom constituting an ester bond by a tertiary carbon atom or an acrylic acid ester monomer having a hydrocarbon group (an alicyclic hydrocarbon group, an aliphatic hydrocarbon group, a group bonded by these groups and others) at an adjacent position of oxygen atom constituting an ester bond and then bonded to the said hydrocarbon group by —COOR group (wherein R is a tertiary hydrocarbon group, 2-tetrahydrofuranyl group, 2-tetrahydropyranyl group or others) directly or through a combining-group, acid-eliminating function can be provided. These acryl acid ester monomers can be used alone or in combination of 2 or more sorts.

In W² of the formula (8a), as a bivalent hydrocarbon group, there may be mentioned the same as a bivalent hydrocarbon group in the said W¹. A preferable example of W² includes a group represented by the formula (9); 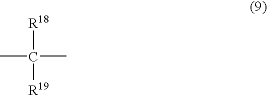
wherein R¹⁸ and R¹⁹ are the same or different and are each hydrocarbon or a hydrocarbon group. R¹⁸ and R¹⁹ may be combined with each other together with the adjacent carbon atom to form an alicyclic ring.

As a hydrocarbon group in R¹⁸ and R¹⁹, there may be mentioned an aliphatic hydrocarbon group (an alkyl group of from about 1 to about 20 carbon atoms, an alkenyl group of from about 2 to about 20 carbon atoms, an alkynyl group of from about 2 to about 20 carbon atoms and so on), an alicyclic hydrocarbon group (a cycloalkyl group of from about 3 to about 20 members, a cycloalkenyl group of from about 3 to about 20 members, a bridged-cyclic hydrocarbon group and so on), an aromatic hydrocarbon group (an aromatic hydrocarbon group of from about 6 to about 14 carbon atoms and so on) and a group combined by 2 or more of them. The said hydrocarbon group also includes a hydrocarbon group which have a substituent. As the said substituent, there may be mentioned the same as substituents the bivalent hydrocarbon group of the said W¹ may have.

Preferable R¹⁸ and R¹⁹ include a hydrogen atom; a methyl, an ethyl, a propyl, an isopropyl, a butyl, an isobutyl, a s-butyl, a t-butyl, a pentyl, an isopentyl, a hexyl, a heptyl, an octyl, a nonyl, a decyl, a dodecyl group, and other linear or branched-chain alkyl groups of from about 1 to about 15 carbon atoms (preferably from about 1 to about 12); trifluoromethyl, pentafluoroethyl, 2,2,2-trifluoroethyl, 2,2,2-trifluoro-1-(trifluoromethyl)ethyl, heptafluoropropyl, 2,2,3,3,3-pentafluoropropyl, 2,2,3,3-tetrafluoropropyl, nonafluorobutyl, 2,2,3,3,4,4,4-heptafluorobutyl, 2,2,3,3,4,4-hexafluorobutyl, undecafluoropentyl, 2,2,3,3,4,4,5,5,5-nonafluoropentyl, 2,2,3,3,4,4,5,5-octafluoropentyl, tridecafluorohexyl, 2,2,3,3,4,4,5,5,6,6,6-undacafluorohexyl, 2,2,3,3,4,4,5,5,6,6-dacafluorohexyl, pentadecafluoroheptyl, 2,2,3,3,4,4,5,5,6,6,7,7,7-tridecafluoroheptyl, 2,2,3,3,4,4,5,5,6,6,7,7-dodecafluoroheptyl, heptadecafluorooctyl, 2,2,3,3,4,4,5,5,6,6,7,7,8,8,8-heptadecafluorooctyl, nonadecafluorononyl, 2,2,3,3,4,4,5,5,6,6,7,7,8,8,9,9,9-heptadecafluorononyl, heneicosafluorodecyl, 2,2,3,3,4,4,5,5,6,6,7,7,8,8,9,9,10,10,10-nonadecafluorodecyl group and other linear or branched-chain fluoroalkyl group of from about 1 to about 15 carbon atoms (preferably from about 1 to about 12, and more preferably from about 2 to about 10); a cyclopentyl group, a cyclohexyl group, and other cycloalkyl groups which may have a substituent; a norbornane-2-yl group, an adamantane-1-yl group, and other bridged cyclic groups which may have a substituent; and others. As the substituent the cycloalkyl group or a bridged cyclic group may have, there may be mentioned the same as the substituent the rings in the said formulae (6a) to (6h) may have.

As an alkyl group and a fluoroalkyl group in R¹⁴, R¹⁵ or R¹⁶, the same as the alkyl group and the fluoroalkyl group in the said R¹, R² or R³ can be exemplified, respectively. As R¹⁴, a hydrogen atom, a fluorine atom, an alkyl group of from 1 to 3 carbon atoms such as a methyl group or a fluoroalkyl group of from 1 to 3 carbon atoms such as a trifluoromethyl group is preferable. As R¹⁵ or R¹⁶, a hydrogen atom, an alkyl group of from 1 to 3 carbon atoms such as a methyl group or a fluoroalkyl group of from 1 to 3 carbon atoms such as a trifluoromethyl group, and particularly a hydrogen atom is preferable, respectively. An alkyl group in R¹⁷ which may have a substituent is the same as an alkyl group in the said R⁸ which may have a substituent.

Among the compound represented by the formula (8a), a compound represented by the following formula (8a-1) or (8a-2); 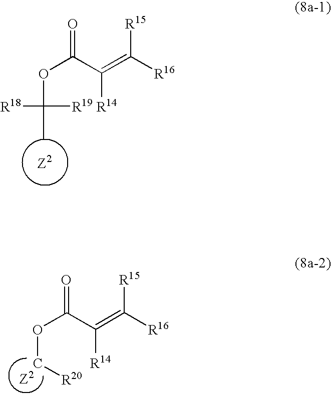
wherein each of a ring Z², R¹⁴, R¹⁵, R¹⁶, R¹⁸ and R¹⁹ is the same meanings as described above. R²⁰ is a hydrogen atom, a fluorine atom, an alkyl group or a fluoroalkyl group; is preferable.

As an alkyl group and a fluoroalkyl group in R²⁰, the same as the alkyl group and the fluoroalkyl group in the said R¹, R² and R³ can be exemplified, respectively.

As typical examples of a compound represented by the formula (8a-1), following compounds can be exemplified. As a typical compound comprising a compound where the ring Z² is the ring represented by the formula (6a), there may be mentioned, for example, 2-[1-(2-trifluoromethyl-2-propenoyloxy)-1-methylethyl]norbornane, 2-[1-(2-trifluoromethyl-2-propenoyloxy)-1,2-dimethylpropyl]norbornane, 2-[1-(2-trifluoromethyl-2-propenoyloxy)-1-methylpentyl]norbornane, 2,3-bis (trifluoromethyl)-5-[1-(2-trifluoromethyl-2-propenoyloxy)-1-methylpentyl]norbornane, 1,2,3,3,4,5,5,6,6,7,7-undecafluoro-2-[1-(2-trifluoromethyl-2-propenoyloxy)-1-methylpentyl]norbornane, 2-[3,3,3-trifluoro-1-(2-trifluoromethyl-2-propenoyloxy)-1-methylpropyl]norbornane, 2-[3,3,4,4,5,5,6,6,7,7,8,8,9,9,10,10,10-heptadecafluoro-1-(2-trifluoromethyl-2-propenoyloxy)-1-methyldecyl]norbornane, 2-[3,3,3-trifluoro-1-(2,2,2-trifluoroethyl)-1-(2-trifluoromethyl-2-propenoyloxy)propyl]norbornane, 2-[3,3,3-trifluoro-1-(2,2,2-trifluoroethyl)-1-(2-trifluoromethyl-2-propenoyloxy)propyl]-2-trifluoromethylnorbornane, 2-[3,3,4,4,5,5,6,6,7,7,8,8,9,9,10,10,10-heptadecafluoro-1-(2-trifluoromethyl-2-propenoyloxy)-1-methyldecyl]tetracyclo[4.4.0^{2,5}.1^{7,10}]dodecane, 2-[1-(2-trifluoromethyl-2-propenoyloxy)-1-methylpentyl]-7-oxabicyclo[2.2.1]heptane, and other compounds where R¹⁴ is trifluoromethyl group, a compound corresponding to the aforementioned compound where R¹⁴ is a fluorine atom, a hydrogen atom or methyl group, and so on.

As a typical example comprising a compound where the ring Z² is the ring represented by the formula (6b), there may be mentioned, for example, 1-[1-(2-trifluoromethyl-2-propenoyloxy)-1-methylethyl]cyclohexane, 1[2,2,2-trifluoro-1-(2-trifluoromethyl-2-propenoyloxy)-1-methylethyl]cyclohexane, 1-[3,3,4,4,5,5,6,6,7,7,8,8,9,9,10,10,10-heptadecafluoro-1-(2-trifluoromethyl-2-propenoyloxy)-1-methyldecyl]cyclohexane, 3-[1-(2-trifluoromethyl-2-propenoyloxy)-1-methylethyl]-tricyclo[6.2.1.0^{2,7}]undecane, 3-[2,2,2-trifluoro-1-(2-trifluoromethyl-2-propenoyloxy)-1-methylethyl]-tricyclo[6.2.1.0^{2,7}]undecane, 3-[3,3,4,4,5,5,6,6,7,7,8,8,9,9,10,10,10-heptadecafluoro-1-(2-trifluoromethyl-2-propenoyloxy)-1-methyldecyl]-tricyclo[6.2.1.0^{2,7}]undecane, and other compounds where R¹⁴ is a trifluoromethyl group, a compound corresponding to the said compound where R¹⁴ is a fluorine atom, a hydrogen atom or a methyl group and so on.

As a typical example of the compound where the ring Z² is the ring represented by the formula (6c), there may be mentioned, for example, 1-[1-(2-trifluoromethyl-2-propenoyloxy)-1-methylethyl]adamantane, 1-[2,2,2-trifluoro-1-(2-trifluoromethyl-2-propenoyloxy)-1-methylethyl]adamantane, 1-fluoro-3-[1-(2-trifluoromethyl-2-propenoyloxy)-1-methylethyl]adamantane, 1,3-difluoro-5-[1-(2-trifluoromethyl-2-propenoyloxy)-1-methylethyl]adamantane, 1,3,5-trifluoro-7-[1-(2-trifluoromethyl-2-propenoyloxy)-1-methylethyl]adamantane, 2,2,3,4,4,5,6,6,7,8,8,9,9,10,10-pentadecafluoro-1-[1-(2-trifluoromethyl-2-propenoyloxy)-1-methylethyl]adamantane, 1-[3,3,3-trifluoro-1-(2-trifluoromethyl-2-propenoyloxy)-1-methylpropyl]adamantane, 1-[3,3,4,4,5,5,6,6,7,7,8,8-dodecafluoro-1-(2-trifluoromethyl-2-propenoyloxy)-1-methyloctyl]adamantane, 1-[3,3,3-trifluoro-1-(2,2,2-trifluoroethyl)-1-(2-trifluoromethyl-2-propenoyloxy)propyl]adamantane, and other compounds in which R¹⁴ is a trifluoromethyl group, a compound corresponding to the said compound in which R¹⁴ is a fluorine atom, a hydrogen atom or a methyl group and so on.

As a typical example of a compound represented by the formula (8a-2), following compounds are exemplified. As a typical example of the compound in which the ring Z² is the ring represented by the formula (6a), there may be mentioned, for example, 2-(2,2,2-trifluoroethyl)-2-(2-trifluoromethyl-2-propenoyloxy)norbornane, 2-nonafluorobutyl-5-(2-trifluoromethyl-2-propenoyloxy)-5-methylnorbornane, 2,3,3,4,4,5,5,6-octafluoro-8-(2-trifluoromethyl-2-propenoyloxy)-8-methyltricyclo[5.2.1.0^{2,6}]decane, 2-(2-trifluoromethyl-2-propenoyloxy)norbornane, 3-hydroxy-4-(2-trifluoromethyl-2-propenoyloxy)tetracyclo[4.4.0.1^{2,5}.1^{7,10}]dodecane, 3-hydroxy-8-(2-trifluoromethyl-2-propenoyloxy)tetracyclo[4.4.0.1^{2,5}.1^{7,10}]dodecane, 3-hydroxymethyl-8-(2-trifluoromethyl-2-propenoyloxy)tetracyclo[4.4.0.1^{2,5}.1^{7,10}]dodecane, 3-hydroxymethyl-9-(2-trifluoromethyl-2-propenoyloxy)tetracyclo[4.4.0.1^{2,5}.1^{7,10}]dodecane, 8-hydroxy-3-(2-trifluoromethyl-2-propenoyloxymethyl)tetracyclo[4.4.0.1^{2,5}.1^{7,10}]dodecane, 9-hydroxy-3-(2-trifluoromethyl-2-propenoyloxy)tetracyclo[4.4.0.1^{2,5}.1^{7,10}]dodecane, 2-nonafluorobutyl-5-(2-trifluoromethyl-2-propenoyloxy)norbornane, 2-tridecafluorohexyl-5-(2-trifluoromethyl-2-propenoyloxy)norbornane, 2-tridecafluorohexyl-5-(2-trifluoromethyl-2-propenoyloxy)-7-oxabicyclo[2.2.1]heptane, 3-tridecafluorohexyl-8-(2-trifluoromethyl-2-propenoyloxy)tetracyclo[4.4.0.1^{2,5}.1^{7,10}]dodecane, 2,3,3,4,4,5,5,6-octafluoro-8-(2-trifluoromethyl-2-propenoyloxy)tricyclo[5.2.1.0^{2,6}]decane, 2,3,3,4,4,5,5,6-octafluoro-8-(2-trifluoromethyl-2-propenoyloxy)-10-oxatricyclo[5.2.1.0^{2,6}]decane, 2,3,3,4,4,5,5,6,6,7-decafluoro-9-(2-trifluoromethyl-2-propenoyloxy)tricyclo[6.2.1.0^{2,7}]undecane, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6b), there may be mentioned, for example, 1-(2-trifluoromethyl-2-propenoyloxy)cyclopentane, 1-(2-trifluoromethyl-2-propenoyloxy)cyclohexane, cis-5-(2-trifluoromethyl-2-propenoyloxy)-1,1,3-trimethylcyclohexane, trans-5-(2-trifluoromethyl-2-propenoyloxy)-1,1,3-trimethylcyclohexane, 2-(2-trifluoromethyl-2-propenoyloxy)-1-isopropyl-4-methylcyclohexane, 3-(2-trifluoromethyl-2-propenoyloxy)tricyclo[6.2.1.0^{2,7}]undecane, 4-(2-trifluoromethyl-2-propenoyloxy)tricyclo[6.2.1.0^{2,7}]undecane, 2-(2-trifluoromethyl-2-propenoyloxy)-7-oxabicyclo[3.2.1]octane-6-on, 1-nonafluorobutyl-4-(2-trifluoromethyl-2-propenoyloxy)cyclohexane, 1-tridecafluorohexyl-4-(2-trifluoromethyl-2-propenoyloxy)cyclohexane, 2-tridecafluorohexyl-6-(2-trifluoromethyl-2-propenoyloxy)perhydronaphthalene, 1,1,2,2,3,3,3a,7a-octafluoro-5-(2-trifluoromethyl-2-propenoyloxy)perhydroindene, 1,1,2,2,3,3,4,4,4a,8a-decafluoro-6-(2-trifluoromethyl-2-propenoyloxy)decalin, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6c), there may be mentioned, for example, 2-(2,2,2-trifluoroethyl)-2-(2-trifluoromethyl-2-propenoyloxy)adamantane, 1-fluoro-4-(2-trifluoromethyl-2-propenoyloxy)-4-methyladamantane, 1,3-difluoro-6-(2-trifluoromethyl-2-propenoyloxy)-6-methyladamantane, 1-(2-trifluoromethyl-2-propenoyloxy)adamantane, 2-(2-trifluoromethyl-2-propenoyloxy)adamantane, 2-(2-trifluoromethyl-2-propenoyloxy)-2-methyladamantane, 2-ethyl-2-(2-trifluoromethyl-2-propenoyloxy)adamantane, 1-(2-trifluoromethyl-2-propenoyloxy)-3-hydroxyadamantane, 1-(2-trifluoromethyl-2-propenoyloxy)-3,5-dihydroxyadamantane, 1-(2-trifluoromethyl-2-propenoyloxy)-3,5,7-trihydroxyadamantane, 5-(2-trifluoromethyl-2-propenoyloxy)-1,3-dimethyladamantane, 1-(2-trifluoromethyl-2-propenoyloxy)-3-hydroxy-5,7-dimethyl adamantane, 1-carboxy-3-(2-trifluoromethyl-2-propenoyloxy)adamantane, 1-amino-3-(2-trifluoromethyl-2-propenoyloxy)adamantane, 3-(2-trifluoromethyl-2-propenoyloxy)-1-nitroadamantane, 3-(2-trifluoromethyl-2-propenoyloxy)-1-sulfoadamantane, 1-t-butyloxycarbonyl-3-(2-trifluoromethyl-2-propenoyloxy)adamantane, 1-(2-trifluoromethyl-2-propenoyloxy)-4-oxoadamantane, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6d), there may be mentioned, for example, 8-(2-trifluoromethyl-2-propenoyloxy)-4-oxatricyclo[5.2.1.0^{2,6}]decane-3,5-dion, 4-(2-trifluoromethyl-2-propenoyloxy)-11-oxapentacyclo[6.5.1.1^{3,6}.0^{2,7}.0^{9,13}]pentadecane-10,12-dion, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6e), there may be mentioned, for example, α-(2-trifluoromethyl-2-propenoyloxy)-γ-butyrolactone, β-(2-trifluoromethyl-2-propenoyloxy)-γ-butyrolactone, γ-(2-trifluoromethyl-2-propenoyloxy)-γ-butyrolactone, α-(2-trifluoromethyl-2-propenoyloxy)-γ,γ-dimethyl-γ-butyrolactone, α-(2-trifluoromethyl-2-propenoyloxy)-α,γ,γ-trimethyl-γ-butyrolactone, 8-(2-trifluoromethyl-2-propenoyloxy)-4-oxatricyclo[5.2.1.0^{2,6}]decane-3-on, 9-(2-trifluoromethyl-2-propenoyloxy)-4-oxatricyclo[5.2.1.0^{2,6}]decane-3-on, and other compounds in which R¹⁴ is a trifluoromethyl group, a compound corresponding to the said compound in which R¹⁴ is a fluorine atom, a hydrogen atom or a methyl group and so on.

As a typical example in which the ring Z² is the ring represented by the formula (6f), there may be mentioned, for example, 4-(2-trifluoromethyl-2-propenoyloxy)-2,7-dioxabicyclo[3.3.0]octane-3,6-dion, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6g), there may be mentioned, for example, 5-(2-trifluoromethyl-2-propenoyloxy)-3-oxatricyclo[4.2.1.0^{4,8}]nonane-2-on, 5-methyl-5-(2-trifluoromethyl-2-propenoyloxy)-3-oxatricyclo[4.2.1.0^{4,8}]nonane-2-on, 9-methyl-5-(2-trifluoromethyl-2-propenoyloxy)-3-oxatricyclo[4.2.1.0^{4,8}]nonane-2-on, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (6h), there may be mentioned, for example, 6-(2-trifluoromethyl-2-propenoyloxy)-3-oxatricyclo[4.3.1.1^{4,8}]undecane-2-on, 8-(2-trifluoromethyl-2-propenoyloxy)-6-hydroxy-3-oxatricyclo[4.3.1.1^{4,8}]undecane-2-on, 6-(2-trifluoromethyl-2-propenoyloxy)-8-hydroxy-3-oxatricyclo[4.3.1.1^{4,8}]undecane-2-on, and other compounds in which R¹⁴ is a trifluoromethyl group, a compound corresponding to the said compound in which R¹⁴ is a fluorine atom, a hydrogen atom or a methyl group and so on.

As a typical example of the compound in which the ring Z² is the ring represented by the formula (8b), there may be mentioned, for example, 2-trifluoromethyl-2-methyl propenoate, 2-trifluoromethyl-2-ethyl propenoate, 2-trifluoromethyl-2-propyl propenoate, 2-trifluoromethyl-2-isopropyl propenoate, 2-trifluoromethyl-2-s-butyl propenoate, 2-trifluoromethyl-2-t-butyl propenoate, 2-trifluoromethyl-2-hexyl propenoate, 2-trifluoromethyl-2-(2-hydroxyethyl)propenoate, 2-trifluoromethyl-2-trifluoromethyl propenoate, 2-trifluoromethyl-2-(2,2,2-trifluoroethyl)propenoate, 2-trifluoromethyl-2-(2,2,3,3,3-pentafluoropropyl)propenoate, 2-trifluoromethyl-2-(2,2,3,3-tetrafluoropropyl)propenoate, 2-trifluoromethyl-2-(2,2,3,3,4,4,4-heptafluorobutyl)propenoate, 2-trifluoromethyl-2-(2,2,3,3,4,4-hexafluorobutyl)propenoate, 2-trifluoromethyl-2-(2,2,3,3,4,4,5,5,5-nonafluoropentyl)propenoate, 2-trifluoromethyl-2-(2,2,3,3,4,4,5,5-octafluoropentyl)propenoate, 2-trifluoromethyl-2-(2,2,3,3,4,4,5,5,6,6,7,7,7-tridecafluoroheptyl)propenoate, 2-trifluoromethyl-2-(2,2,3,3,4,4,5,5,6,6,7,7-dodecafluoroheptyl)propenoate, 2-trifluoromethyl-2-(3,3,4,4,5,5,6,6,7,7,8,8,9,9,10,10,10-heptadecafluorodecyl)propenoate, 2-trifluoromethyl-2-(2,2,3,3,4,4,5,5,6,6,7,7,8,8,9,9,10,10,11,11-icosafluoroundecyl)propenoate, 2-trifluoromethyl-2-(2,2,2-trifluoro-1-trifluoromethylethyl)propenoate, 2-trifluoromethyl-2-(1,2,2,2-tetrafluoro-1-trifluoromethylethyl)propenoate, 2-trifluoromethyl-2-[1,1-bis(trifluoromethyl)ethyl]propenoate, 2-trifluoromethyl-2-(1-trifluoromethyl-1-methylethyl)propenoate, 2-trifluoromethyl-2-(2,2,2-trifluoro-1-trifluoromethyl-1-phenylethyl)propenoate, 2-trifluoromethyl-2-(1-trifluoromethyl-1-phenylethyl)propenoate, and other compounds where R¹⁴ is a trifluoromethyl group, a compound corresponding to the said compound in which R¹⁴ is a fluorine atom, a hydrogen atom or a methyl group and so on.

In the said acryl monomer, (1) the compound represented by the formula (8a) in which the ring Z² is the ring represented by the formula (6d), (6e), (6f), (6g) or (6h), (2) the compound represented by the formula (8a) in which the ring Z² is the ring represented by the formula (6a), (6b) or (6c) and the ring Z² is combined with the said polar group or a group having a polar group or W² is a group having a polar group, (3) the compound represented by the formula (8b) in which R¹⁷ is a group having a polar group are subjected to co-polymerization as co-monomer to form a repeated unit having adhesion to substrate and/or hydrophilicity by.

Further, in the said acryl monomer, (1) a compound represented by the formula (8a) having a tertiary carbon atom at an oxygen atom —O— constituting an ester bond represented in the formula, [for example, the compound represented by the formula (8a-1) or (8a-2) and so on], (2) a compound represented by the formula (8a) where —COOR group (R is a tertiary hydrocarbon group, a 2-tetrahydrofuranyl group, 2-tetrahydropyranyl group or others) is combined with the ring Z² directly or through a combining-group, (3) a compound represented by the formula (8b) where R¹⁷ is a tertiary hydrocarbon group, and (4) a compound represented by the formula (8b) where —COOR group (R is a tertiary hydrocarbon group, a 2-tetrahydrofuranyl group, 2-tetrahydropyranyl group or others) is combined with the ring R¹⁷ directly or through a linkage group are subjected to co-polymerization as a co-monomer to form a repeated unit having acid-elimination function.

The said acryl monomer can be produced by a known method or by applying a known reaction. For example, a fluorine atom-containing or non-containing unsaturated carboxylic acid or derivatives thereof (an acid halide, an acid anhydride, an ester and so on) is allowed to react with a hydroxy compound according to a commonly used esterification method using base, acid catalyst, or ester exchanging catalyst, and then the corresponding said acryl monomer can be obtained.

As another example of a polymerizable unsaturated monomer used for providing various functions as resist to a polymeric compound of the present invention except for a monomer of the present invention, there may be mentioned a cyclic unsaturated monomer represented by the following formula (10a) or (10b); 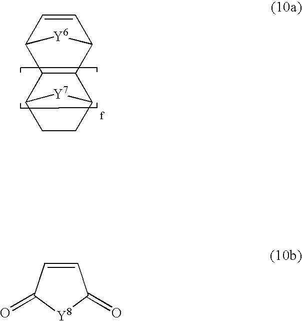
wherein, in the formula (10a) or (10b), Y⁶ and Y⁷ are each an alkylene group, an oxygen atom, a sulfur atom or no-bonding. Y⁸ is an oxygen atom or an —NH— group. f denotes an integer of from 0 to 3. An atom constituting the ring in the formulae may have a substituent.

Among these cyclic unsaturated monomers, the compound represented by formula (10a) can improve resistance to etching of a polymer, while the compound represented by formula (10b) can enhance adhesion to substrate. Further, the said cyclic unsaturated monomer where having a fluorine atom or a group having a fluorine atom in a ring can improve transparency to light having a wavelength of 300 nm or less, particularly vacuum ultraviolet light, can be improved. In case of combining with the said polar group or a group having the said polar group, adhesion to substrate and/or hydrophilicity can be enhanced. In addition, in case of having an ester group where an oxygen atom constituting an ester bond is combined with a tertiary carbon atom, acid-elimination function can be improved. These cyclic unsaturated monomer can be used alone or in combination of two or more sorts.

In the formula, the said alkylene group is the same as an alkylene group in Y¹ and others. As a substituent the ring may have, there may be mentioned the same as the substituents the ring Z¹ [the ring represented by formulae (6a) to (6h)] may have. When the number of substituent of the ring is 2 or more, they may be combined with each other to form a 4- or more membered ring such as a cycloalkane ring and a lactone ring together with a carbon atom constituting the ring. These rings may have a substituent such as a fluorine atom (the same substituent as a substituent which may be had by an atom constituting the said ring Z¹).

As a typical example of a cyclic unsaturated monomer represented by the formula (10a), there may be mentioned, for example, norbornane (=bicyclo[2.2.1]-2-heptene), 5-carboxy-5-trifluoromethylbicyclo[2.2.1]-2-heptene, 5-t-butoxycarbonyl-5-trifluoromethylbicyclo[2.2.1]-2-heptene, 7-oxa-bicyclo[2.2.1]-2-heptene, tricyclo[4.3.0.1^{2,5}]-3-decene, tricyclo[4.4.0.1^{2,5}]-3-undecene, tetracyclo[4.4.0.1^{2,5}.1^{7,10}]-3-dodecene, 4-oxatricyclo[5.2.1.0^{2,6}]-8-decene-3-on, 4-oxatricyclo[5.2.1.0^{2,6}]-8-decene-3,5-dion and others.

As a typical example of a cyclic unsaturated monomer represented by the formula (10b), there may be mentioned, for example, maleic anhydride, 2-fluoromaleic anhydride, 2-trifluoromethylmaleic anhydride, maleimide, N-carboxymaleimide, N-methylmaleimide and others.

In the said cyclic unsaturated monomer, (1) a compound represented by the formula (10a) where the said polar group or a group having a polar group to a ring is combined with the ring, and (2) a compound represented by the formula (10b) are subjected to co-polymerization as a co-monomer to form a repeated unit having adhesion to substrate and/or hydrophilicity. The said cyclic unsaturated monomer can be produced by a known method or applying a known reaction.

In a polymeric compound of the present invention, a ratio of repeated unit corresponding to a polymerizable monomer represented by the formula (1) is not specifically limited, and is generally from about 1 to about 99% by mole, preferably from about 3 to about 95% by mole, more preferably from about 5 to about 80% by mole, and specifically from about 5 to about 70% by mole, relative to all the monomer units constituting the polymer. A ratio of the repeated unit having acid-eliminating function is, for example, from about 5 to about 80% by mole, and preferably from about 10 to about 60% by mole, relative to all the monomer units constituting the polymer. Further, rates of a repeated unit corresponding to the vinyl ether monomer represented by the formula (5a) or (5b), a repeated unit corresponding to the acrylic acid ester monomer represented by the formula (8a) or (8b), and a repeated unit corresponding to the cyclic unsaturated monomer represented by the formula (10a) or (10b) can be appropriately selected depending on the function each monomer units have. Total ratio of these repeated units is from about 1 to about 99% by mole, preferably from about 5 to about 97% by mole, and more preferably from 20 to 95% by mole, specifically from about 30 to 95% by mole, relative to all monomer units constituting a polymer.

When the polymeric monomer of the present invention in allowed to (co-)polymerize to obtain a polymerizable monomer, polymerization can be performed by solution polymerization, bulk polymerization, suspension polymerization, bulk-suspension polymerization and emulsion polymerization and other commonly used method used in the production of acryl polymer and others, and particularly solution polymerization is preferable. In the solution polymerization, dropwise polymerization may be applied in order to obtain homogeneous quality of polymer.

As a polymerization solvent, a conventional solvent can be used and there may be mentioned, for example, an ether (diethyl ether, glycol ethers such as propylene glycol monomethyl ether, and other linear-chain ethers, tetrahydrofuran, dioxane, and other cyclic ethers), an ester (methyl acetate, ethyl acetate, butyl acetate, ethyl lactate, a glycol ether esters such as propylene glycol monomethyl ether acetate and so on), a ketone (acetone, methyl ethyl ketone, methyl isobutyl ketone, cyclohexanone and so on), an amide (N,N-dimethylacetoamide, N,N-dimethylformamide and so on), a sulfoxide (dimethylsulfoxide and so on), an alcohol (methanol, ethanol, propanol and so on), a hydrocarbon (an aromatic hydrocarbon such as benzene, toluene and xylene, an aliphatic hydrocarbon such as hexane, an alicyclic hydrocarbon such as cyclohexane, and others), a mixed solvent thereof and so on. Further, as a polymerization initiator, a conventional polymerization initiator can be applied. A polymerization temperature can be appropriately selected, for example, in a scope of from about 30 to about 150° C.

A polymer obtained by polymerization can be purified by precipitation or reprecipitation. A solvent for precipitation or reprecipitation may be either an organic solvent or water and further a mixing solvent may be well. As an organic solvent used for precipitation or reprecipitation solvent, there may be mentioned, for example, a hydrocarbon (pentane, hexane, heptane, octane, and other aliphatic hydrocarbons; cyclohexane, methylcyclohexane, and other alicyclic hydrocarbons; benzene, toluene, xylene, and other aromatic hydrocarbons), a halogenated hydrocarbon (a halogenated aliphatic hydrocarbon such as methylene chloride, chloroform and carbon tetrachloride; a halogenated aromatic hydrocarbon such as chlorobenzene and dichlorobenzene, and so on), a nitro compound (such as nitromethane and nitroethane), a nitrile (such as acetonitrile and benzonitrile), an ether (a linear chain ether such as diethyl ether, diisopropyl ether and dimethoxyethane; a cyclic ether such as tetrahydrofuran and dioxane), a ketone (such as acetone, methyl ethyl ketone and diisobutyl ketone), an ester (such as ethyl acetate and butyl acetate), a carbonate (such as dimethyl carbonate, diethyl carbonate, ethylene carbonate and propylene carbonate), an alcohol (such as methanol, ethanol, propanol, isopropylalcohol and butanol), a carboxylic acid (such as acetic acid), a mixed solvent containing these solvent and so on.

A weight average molecular weight (Mw) of a polymeric compound is, for example, from about 1000 to about 500000, preferably from about 3000 to about 50000, and a molecular weight distribution (Mw/Mn) is, for example, from about 1.5 to about 2.5. Incidentally, the said Mn is a number average molecular weight and both Mn and Mw are in terms of polystyrene.

[Resin Compositions for Photoresist and Process for Producing a Semiconductor]

A photoresist resin composition of the present invention contains at least a polymeric compound of the said present invention and a photosensitive acid generator. Incidentally, the photoresist resin composition may contain a polymer except for the polymeric compound as far as adversary affected to the resist function.

As a photosensitive acid generator, a compound commonly used or conventional as effectively providing acid by the action of exposure, for example, a diazonium salt, an iodonium salt (for example, diphenyl iodo hexafluorophosphate and so on), a sulfonium salt (for example, triphenyl sulfonium hexafluoroantimonate, triphenyl sulfonium hexafluorophosphate, triphenyl sulfonium methane sulfonate and so on), a sulfonic acid ester [for example, 1-phenyl-1-(4-methylphenyl)sulfonyloxy-1-benzoylmethane, 1,2,3-trisulfonyloxymethylbenzene, 1,3-dinitro-2-(4-phenylsulfonyloxymethyl)benzene, 1-phenyl-1-(4-methylphenylsulfonyloxymethyl)-1-hydroxy-1-benzoylmethane and so on], an oxathiazol derivative, s-triazine derivative, a disulfone derivative (such as diphenyldisulfone), an imide compound, an oxime sulfonate, diazonaphtoquinone, benzoin tosylate and others can be applied. These photosensitive acid generators can be used by alone or in combination of 2 or more sorts.

The amount of photosensitive acid generator can be appropriately selected depending on strength of the acid generated by photo-exposure, a ratio of each repeated unit of the polymer and others, and for example, from about 0.1 to about 30 part by weight, preferably from about 1 to about 25 part by weight, and preferably from about 2 to about 20 part by weight, relative to 100 part by weight of the polymeric compound.

A photoresist resin composition may contain, if necessary, an alkali soluble component such as an alkali soluble resin (for example, a novolac resin, a phenol resin, an imide resin, carboxyl group-containing resin and so on), a coloring agent (for example, dyes), an organic solvent (for example, such as hydrocarbons, halogenated hydrocarbons, alcohols, esters, amides, ketones, ethers, cellosolves, carbitols, glycol ether esters, and mixed solvent of them), a basic compound (such as a hindered amine), a detergent, a anti-soluble agent, a sensitizer, a stabilizer and others.

A photoresist resin composition obtained by these procedures is coated on a base or substrate, and dried, the applied film (resist film) is exposed to light (or, further baked after exposure) to form a latent pattern, and is subsequently developed to form a fine pattern with a high degree of precision.

As a base or substrate, there may be mentioned silicon wafer, metal, plastics, glass, ceramic and so on. The photoresist resin composition can be applied using a conventional application means such as a spin coater, a dip coater, a roller coater. The applied film has a thickness of, for example, from about 0.01 to about 20 μm, and preferably from about 0.05 to about 1 μm.

Light rays with different wavelengths such as ultraviolet rays and X-rays can be used in exposure. For example, g-light, i-light, excimer laser (for example, XeCl, KrF, KrCl, ArF, ArCl, F₂, Kr₂, KrAr, Ar₂ and so on) are usually used for semiconductor resist. An exposure energy is, for example, from about 0.1 to about 1000 mJ/cm².

Light irradiation allows the photosensitive acid generator to generate an acid, and the acid allows, for example, the eliminating portion of acid-eliminating group of the said polymeric compound to leave promptly and thereby yields a carboxyl group that contributes to solubilization. Therefore, development with water or an alkaline developing solution can yield a predetermined pattern with a high degree of precision.

### EXAMPLES

The present invention will be illustrated in more detail with reference to several examples below, which is not intended to limit the scope of the invention. Figures of the right-under brackets in the structural formulae of polymers denote % by mole of the prepared monomer corresponding to the repeated unit (monomer unit). A weight average molecular weight (Mw) and a molecular weight distribution (Mw/Mn) are measured by a GPC measurement using a refractometer (RI) and tetrahydrofuran (THF) as a detector and an eluent, respectively in terms of standard polystyrene. Three columns KF-806L (commercial name) manufactured by SHOUWA DENKO Inc. are connected in series to use for GPC and the reaction is performed under the condition comprising the column temperature of 40° C., RI temperature of 40° C., and eluent flow rate of 0.8 ml/min.

### Production Example 1

17.4 g of 2-trifluoromethylacrylic acid chloride was added to a mixed solution of 10.2 g of α-hydroxy-γ-butyrolactone, 11.1 g of triethylamine and 100 ml of tetrahydrofuran, and stirred for 3 hours at room temperature. To the reaction mixture ethyl acetate and water are added, extraction procedure was performed, the concentrate obtained by concentrating the organic layer is allowed to silica gel column chromatography to yield 13.7 g of α-(2-trifluoromethyl-2-propenoyloxy)-γ-butyrolactone represented by the following formula (11).

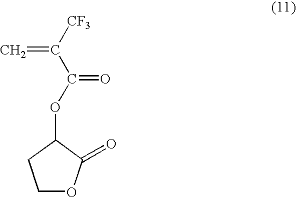

### Production Example 2

To a three-necked flask equipped with a thermometer 19.4 g (0.1 mol) of 1-(1-adamantyl)-1-methylethanol, 30.3 g (0.3 mol) of triethylamine and 200 ml of tetrahydrofuran were added, and was stirred under nitrogen gas stream cooled on ice. To the mixture 22.9 g (0.14 mol) of 2-trifluoromethylacrylic acid chloride, and was stirred for 2 hours at room temperature. After the reaction, 500 ml of pure water was added, tetrahydrofuran and triethylamine were distilled out under reduced pressure, and then 1 L of ethyl acetate was added to perform extraction. An organic layer was washed with 500 ml of 5% by weight sodium hydrogencarbonate aqueous solution and 500 ml of 10% by weight salt aqueous solution in order, was dried using magnesium sulfate, and was concentrated under reduced pressure. The concentrated residue was subjected to silica gel column chromatography and thereby yielded 28 g (0.089 mol) of 1-[1-(2-trifluoromethyl-2-propenoyloxy)-1-methylethyl]adamantane represented by the following formula (12). Incidentally, as the raw material. 1-(1-adamantyl)-1-methylethanol, a compound synthesized by allowing 1-adamantane carboxylic acid chloride to react with methyl magnesium bromide according to the method described in the literature [J. Med. Chem., 14, 535-543 (1971)] was used. 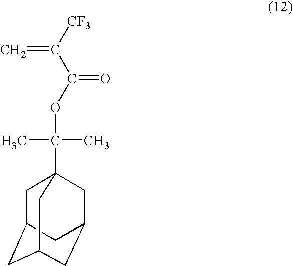
[Spectral Data of 1-[1-(2-trifluoromethyl-2-propenoyloxy)-1-methylethyl]adamantane]

¹H-NMR (DMSO-d₆) δ: 1.46 (s, 6H), 1.56-1.67 (m, 12H), 1.97 (s, 3H), 6.58 (s, 1H), 6.70 (s, 1H)

### Production Example 3

To a three-necked flask equipped with a thermometer 16.6 g (0.1 mol) of 2-methyl-2-adamantanol, 30.3 g (0.3 mol) of triethylamine and 200 ml of tetrahydrofuran ware added, and were stirred under nitrogen stream cooled on ice. To the mixed solution 22.9 g (0.14 mol) of 2-trifluoromethylacrylic acid chloride was added, and was stirred for 2 hours at room temperature. After the reaction, 500 ml of pure water was added, tetrahydrofuran and triethylamine were distilled out under reduced pressure, and to the residue 1 L of ethyl acetate was added, and was extracted. The organic layer was washed with 500 ml of 5% by weight sodium hydrogencarbonate aqueous solution and 500 ml of 10% by weight salt aqueous solution in order, and the obtained residue was dried with magnesium sulfate and was concentrated under reduced pressure. The concentrated residue was subjected to a silica gel column chromatography and thereby yielded 16.1 g (0.056 mol) of 2-(2-trifluoromethyl-2-propenoyloxy)-2-methyladamantane represented by the following formula (13).

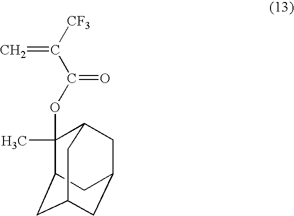

### Production Example 4

To a three-necked flask equipped with Dean Stark equipment and a thermometer 129 g (0.7 mol) of 1,3,5-adamantanetriol, 434 g (3.10 mol) of 2-trifluoromethylacrylic acid, 1.24 g (0.01 mol) of p-methoxyphenol and 745 ml of toluene were added. While heating and refluxing the mixture, a mixture of 6.86 g (0.07 mol) of sulfuric acid and 100 ml of toluene was dropped over 5 minutes, and the hot reflux operation was continued to perform a dehydration reaction. After the reaction, to the mixture 1580 g of 10% by weight sodium carbonate aqueous solution was added to be neutralized. The mixture was allowed to extraction with 2 L and 1 L of n-hexane each once to remove impurities diester and triester. After extracting the water layer with 1 L of ethyl acetate 4 times, the ethyl acetate layer was concentrated up to 1.2 L of the amount of the solution, was washed with 250 g of 10% by weight sodium hydrogencarbonate aqueous solution and 250 g of 20% by weight salt aqueous solution in order. After drying with anhydrous magnesium sulfate, the residue was concentrated up to 500 g of the amount of the solution. To the concentrated solution 1 L of n-hexane was dropped over 30 minutes cooled on ice, and subsequently was stirred for 30 minutes. The precipitated crystal was recovered by filtration, was washed with 200 ml of n-hexane, was dried, and thereby yielded 137 g of 1-(2-trifluoromethyl-2-propenoyloxy)-3,5-dihydroxyadamantane represented by the following formula (14) was obtained. 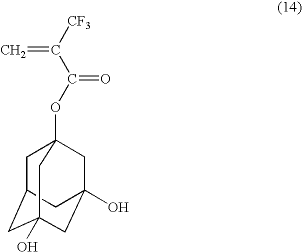
[Spectral Data of 1-(2-trifluoromethyl-2-propenoyloxy)-3,5-dihydroxyadamantane]

¹H-NMR (DMSO-d₆) δ: 1.40-1.50 (m, 5H), 1.54-1.58 (m, 1H), 1.87 (d, 2H), 1.89-1.95 (m, 4H), 2.24 (m, 1H), 4.80 (s, 2H), 6.60 (s, 1H), 6.70 (s, 1H)

### Production Example 5

To a three-necked flask having Dean Stark equipment and a thermometer 150 g of 1,3-adamantanediol, 125 g of 2-trifluoromethylacrylic acid, 18.2 g of p-methoxyphenol, and 1500 g of toluene were added. The mixture was heated up to 80° C., to the mixture a mixed solution of 8.7 g of sulfuric acid and 100 ml of toluene was dropped over 15 minutes, and was hot refluxed for further 2.5 hours to perform the dehydration reaction. After the reacted solution was left to be cooled to room temperature, the extracting operation was performed by adding 1500 g of 5% by weight salt aqueous solution. The water layer was extracted twice with 1.5 L of ethyl acetate each and all the organic layer was put together to distill off the solvent under reduced pressure. The concentrate residue was subjected to silica gel chromatography and thereby yielded 37 g of 1-(2-trifluoromethyl-2-propenoyloxy)-3-hydroxyadamantane represented by the following formula (15). 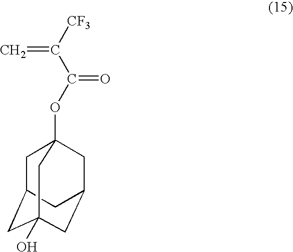
[Spectral Data of 1-(2-trifluoromethyl-2-propenoyloxy)-3-hydroxyadamantane]

¹H-NMR (DMSO-d₆) δ: 1.53-1.72 (m, 8H), 2.05-2.16 (m, 6H), 2.37 (s, 2H), 6.35 (s, 1H), 6.62 (s, 1H)

Incidentally, γ,γ-dimethyl-α-vinyloxy-γ-butyrolactone used as a monomer in the following examples is a compound synthesized by using α-hydroxy-γ,γ-dimethyl-γ-butyrolactone and vinyl acetate according to a method described in Japanese Unexamined Patent Application Publication No. 2003-73321 to be purified by distillation under reduced pressure. In addition, 1,3-dihydroxy-5-vinyloxyadamantane is a compound synthesized by using 1,3,5-adamantenetriol and vinyl acetate according to a method described in Japanese Unexamined Patent Application Publication No. 2003-73321, and subjecting the product to alumina column chromatography to be purified. Further, 1-hydroxy-3-vinyloxyadamantane is a compound synthesized by using 1,3-adamantanediol and vinyl acetate according to a method described in Japanese Unexamined Patent Application Publication No. 2003-73321, and subjecting the product to alumina column chromatography to be purified.

### Example 1

A mixture of 132 g of isosorbide (manufactured by TOKYO KASEI INDUSTRY Inc.), 126 g of α-trifluoromethyl acrylic acid, 8.9 g of sulfuric acid, and 1.5 L of toluene was allowed to hot reflux for 10 hours while removing water by azeotropic distillation with stirring stirred. After cooling the reaction mixture, 500 ml of 10% by weight sodium carbonate aqueous solution was added, and then the organic layer was separated. The organic layer was washed with 500 ml of 10% by weight sodium carbonate aqueous solution, and was concentrated under reduced pressure. The concentrate was subjected to silica chromatography and thereby yielded 56 g of a mixture of 1,4:3,6-dianhydro-D-glucitol 2-(2-trifluoromethyl-2-propenoate) [=2-O-(2-trifluoromethyl-2-propenoyl)-1,4:3,6-dianhydro-D-glucitol] represented by the following formula (A) and 1,4:3,6-dianhydro-D-glucitol 5-(2-trifluoromethyl-2-propenoate) [=5-O-(2-trifluoromethyl-2-propenoyl)-1,4:3,6-dianhydro-D-glucitol] represented by the following formula (B) in the ratio of 32:68 (by weight). 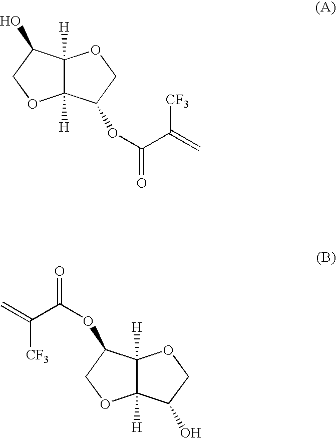
[Spectral Data of 1,4:3,6-dianhydro-D-glucitol 2-(2-trifluoromethyl-2-propenoate)(A)]

¹H-NMR (CDCl₃) δ: 2.83 (brs, 1H), 3.58 (dd, 1H), 3.81 (dd, 1H), 4.08 (m, 2H), 4.32 (s, 1H), 4.54 (d, 1H), 4.65 (t, 1H), 5.37 (d, 1H), 6.49 (d, 1H), 6.75 (d, 1H)

MS m/e 269(M+H), 129

### Example 2

A mixture of 88 g of isosorbide (manufactured by TOKYO KASEI INDUSTRY Inc.), 60 g of vinyl acetate, 38.1 g of sodium carbonate, 700 ml of toluene, and 4.0 g of di-μ-chlorobis(1,5-cyclooctadiene)II iridium (I) was stirred at 90° C. for 4 hours in an atmosphere of argon. Precipitates in the reaction liquid were separated by filtration, and the filtrate was concentrated under reduced pressure. The concentrate was distilled to obtain 21 g of a mixture of 1,4:3,6-dianhydro-D-glucitol 2-vinyl ether [=2-O-vinyl-1,4:3,6-dianhydro-D-glucitol] represented by the following formula (C) and 1,4:3,6-dianhydro-D-glucitol 5-vinyl ether [=5-O-vinyl-1,4:3,6-dianhydro-D-glucitol] represented by the following formula (D). 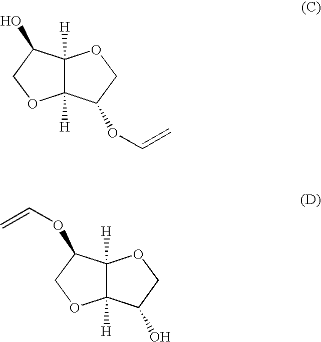
[Spectral Data of 1,4:3,6-dianhydro-D-glucitol 2-vinyl ether (C) and 1,4:3,6-dianhydro-D-glucitol 5-vinyl ether (D)]

MS m/e 173(M+H), 129

### Example 3

Synthesis of the Polymeric Compound of the Following Formula

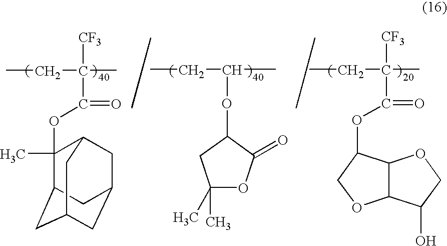

In a round-bottom flask equipped with a reflux condenser, a stirrer and three-way cock, 4.98 g (17.3 mmol) of 2-(2-trifluoromethyl-2-propenoyloxy)-2-methyladamantane, 2.70 g (17.3 mmol) of γ,γ-dimethyl-α-vinyloxy-γ-butyrolactone, 2.32 g (8.6 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1, and 0.10 g of initiator [manufactured by WAKO JUNYAKU INDUSTRY Inc., trade name “V-65”] were placed, and was dissolved in 6.0 g of propylene glycol monomethyl ether acetate (PGMEA). Subsequently, after replacing with dry nitrogen gas in the flask, and was stirred for 3 hours in an atmosphere of nitrogen gas while maintaining the temperature of a reaction system at 60° C. The reaction solution was diluted with 30.0 g of tetrahydrofuran, and the solution was dropped into 500 ml of a mixed solution of hexane and ethyl acetate in the ratio by weight of 9:1, the produced precipitate was purified by filtration. The recovered precipitate was dried under reduced pressure, was dissolved in 35 g of tetrahydrofuran, and subsequently was dropped into 500 ml of a mixed solution of hexane and ethyl acetate in the ratio by weight of 9:1, and the obtained precipitate was removed, and the purification was repeated according to the above procedure. The amount of the polymer obtained after drying under reduced pressure was 8.7 g. The polymer was analyzed by GPC analysis and was found to have a weight average molecular weight of 8200 in terms of the standard polystyrene and a molecular weight distribution of 2.11. In addition, in the result of ¹³C-NMR (in CDCl₃) analysis, the composition of polymer was in the ratio of in the ratio of 41:42:17 (ratio by mole) (in order of from left of the structural formula).

### Example 4

Synthesis of the Polymeric Compound of the Following Formula

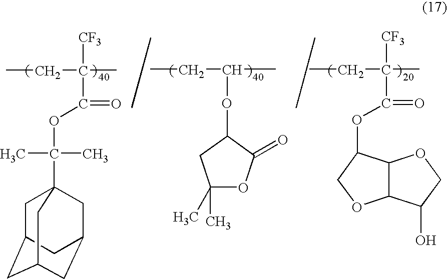

The polymeric compound was synthesized according to the same procedure as Example 3 except for using 5.21 g (16.5 mmol) of 1-[1-(2-trifluoromethyl-2-propenoyloxy)-1-methylethyl]adamantane, 2.57 g (16.5 mmol) of γ,γ-dimethyl-α-vinyloxy-γ-butyrolactone, and 2.21 g (7.9 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1 as monomers of raw material. The amount of the polymer obtained after drying the recovered precipitate under reduced pressure was 8.2 g. The polymer was analyzed by GPC analysis and was found to a weight average molecular weight of 7800 in terms of standard polystyrene and a molecular weight distribution of 2.13. In addition, in the result of ¹³C-NMR (in CDCl₃) analysis, the composition of polymer was in the ratio of in the ratio of 43:42:15 (ratio by mole) (in order of from left of the structural formula).

### Example 5

Synthesis of the Polymeric Compound of the Following Formula

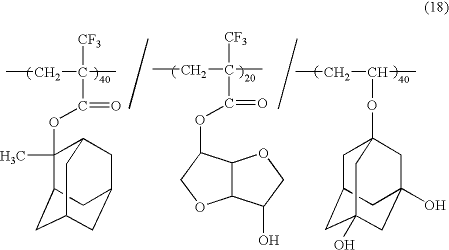

The polymeric compound was synthesized according to the same procedure as Example 3 except for using 4.56 g (15.8 mmol) of 2-(2-trifluoromethyl-2-propenoyloxy)-2-methyladamantane, 2.12 g (7.9 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1 and 3.32 g (15.8 mmol) of 3,5-dihydroxy-1-vinyloxyadamantane as monomers of raw material. After drying under reduced pressure, the amount of the amount of the obtained polymer was 9.2 g. The polymer was analyzed by GPC analysis and was found a weight average molecular weight of 7500 in terms of standard polystyrene and a molecular weight distribution of 2.05. In addition, in the result of ¹³C-NMR (in CDCl₃) analysis, the composition of polymer was in the ratio of in the ratio of 38:22:40 (ratio by mole) (in order of from left of the structural formula).

### Example 6

Synthesis of the Polymeric Compound of the Following Formula

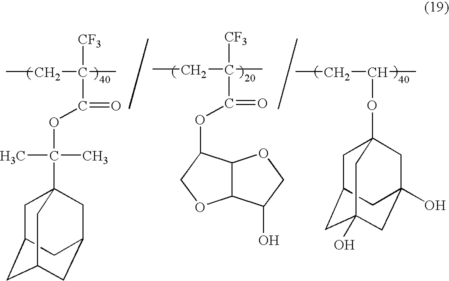

The polymeric compound was synthesized according to the same procedure as Example 3 except for using 4.79 g (15.2 mmol) of 1-[1-(2-trifluoromethyl-2-propenoyloxy)-1-methylethyl]adamantane, 2.03 g (7.6 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1 and 3.18 g (15.2 mmol) of 3,5-dihydroxy-1-vinyloxyadamantane as monomers of raw material. After drying the recovered precipitate under reduced pressure, the amount of the amount of the obtained polymer was 9.2 g. The polymer was analyzed by GPC analysis and was found a weight average molecular weight of 7700 in terms of standard polystyrene and a molecular weight distribution of 2.08. Additionally, in the result of ¹³C-NMR (in CDCl₃) analysis, the composition of polymer was in the ratio of 37:22:41 (ratio by mole) (in order of from left of the structural formula).

### Example 7

Synthesis of the Polymeric Compound of the Following Formula

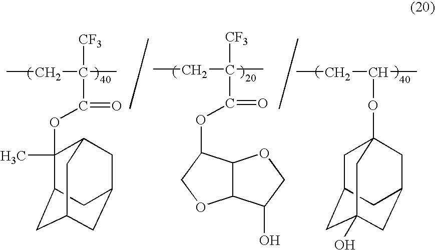

The polymeric compound was synthesized according to the same procedure as Example 3 except for using 4.68 g (16.2 mmol) of 2-(2-trifluoromethyl-2-propenoyloxy)-2-methyladamantane, 2.18 g (8.1 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1 and 3.15 g (16.2 mmol) of 3-hydroxy-1-vinyloxyadamantane as monomers of raw material. After drying the recovered precipitate under reduced pressure, the amount of the obtained polymer was 8.2 g. The polymer was analyzed by GPC analysis and was found a weight average molecular weight of 9700 in terms of standard polystyrene and a molecular weight distribution of 2.18. Additionally, in the result of ¹³C-NMR (in CDCl₃) analysis, the composition of polymer was in the ratio of 38:20:42 (ratio by mole) (in order of from left of the structural formula).

### Example 8

Synthesis of the Polymeric Compound of the Following Formula

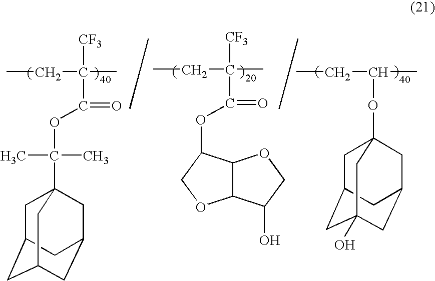

The polymeric compound was synthesized according to the same procedure as Example 3 except for using 4.91 g (15.5 mmol) of 1-[1-(2-trifluoromethyl-2-propenoyloxy)-1-methylethyl]adamantane, 2.08 g (7.8 mmol) of a mixture of 2-O-(2-trifluoromethyl-2-propenoyl)-1,4:3,6-dianhydro-D-glucitol and 5-O-(2-trifluoromethyl-2-propenoyl)-1,4:3,6-dianhydro-D-glucitol obtained in Example 1 and 3.01 g (15.5 mmol) of 3-hydroxy-1-vinyloxyadamantane as monomers of raw material. After drying the recovered precipitate under reduced pressure, the amount of the obtained polymer was 8.9 g. The polymer was analyzed by GPC analysis and was found a weight average molecular weight of 10200 in terms of standard polystyrene and a molecular weight distribution of 2.05. Additionally, in the result of ¹³C-NMR (in CDCl₃) analysis, the composition of polymer was in the ratio of 37:21:42 (ratio by mole) (in order of from left of the structural formula).

### Example 9

Synthesis of the Polymeric Compound of the Following Formula

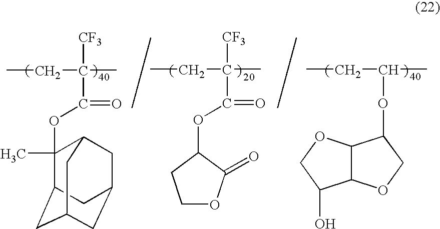

The polymeric compound was synthesized according to the same procedure as Example 3 except for using 5.03 g (17.5 mmol) of 2-(2-trifluoromethyl-2-propenoyloxy)-2-methyladamantane, 1.96 g (8.7 mmol) of α-(α-trifluoromethyl acryloyloxy)-γ-butyrolactone and 3.01 g (17.5 mmol) of a mixture of 2-O-vinyl-1,4:3,6-dianhydro-D-glucitol and 5-O-vinyl-1,4:3,6-dianhydro-D-glucitol obtained in Example 2 as monomers of raw material. After drying the recovered precipitate under reduced pressure, the amount of the obtained polymer was 8.3 g. The polymer was analyzed by GPC analysis and was found a weight average molecular weight of 8500 in terms of standard polystyrene and a molecular weight distribution of 2.15. Additionally, in the result of ¹³C-NMR (in CDCl₃) analysis, the composition of polymer was in the ratio of 38:21:41 (ratio by mole) (in order of from left of the structural formula

### Example 10

Synthesis of the Polymeric Compound of the Following Formula

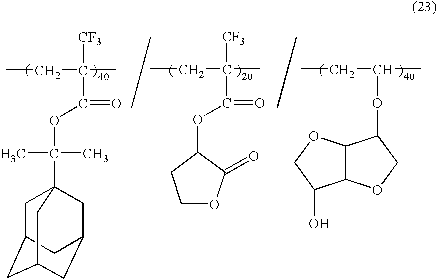

The polymeric compound was synthesized according to the same procedure as Example 3 except for using 5.27 g (16.7 mmol) of 1-[1-(2-trifluoromethyl-2-propenoyloxy)-1-methylethyl]adamantane, 1.87 g (8.3 mmol) of α-(α-trifluoromethyl acryloyloxy)-γ-butyrolactone and 2.87 g (16.7 mmol) of a mixture of 2-O-vinyl-1,4:3,6-dianhydro-D-glucitol and 5-O-vinyl-1,4:3,6-dianhydro-D-glucitol obtained in Example 2 as monomers of raw material. After drying the recovered precipitate under reduced pressure, the amount of the obtained polymer was 8.1 g. The polymer was analyzed by GPC analysis and was found a weight average molecular weight of 8800 in terms of standard polystyrene and a molecular weight distribution of 2.08. Additionally, in the result of ¹³C-NMR (in CDCl₃) analysis, the composition of polymer was in the ratio of 36:22:42 (ratio by mole) (in order of from left of the structural formula

### Example 11

Synthesis of the Polymeric Compound of the Following Formula

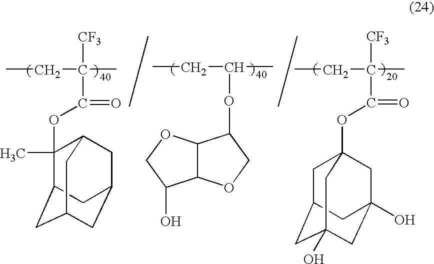

The polymeric compound was synthesized according to the same procedure as Example 3 except for using 4.93 g (15.6 mmol) of 2-(2-trifluoromethyl-2-propenoyloxy)-2-methyladamantane, 2.68 g (15.6 mmol) of a mixture of 2-O-vinyl-1,4:3,6-dianhydro-D-glucitol and 5-O-vinyl-1,4:3,6-dianhydro-D-glucitol obtained in Example 2 and 2.39 g (7.8 mmol) of 1-(2-trifluoromethyl-2-propenoyloxy)-3,5-dihydroxyadamantane as monomers of raw material. After drying the recovered precipitate under reduced pressure, the amount of the obtained polymer was 8.8 g. The polymer was analyzed by GPC analysis and was found a weight average molecular weight of 8300 in terms of standard polystyrene and a molecular weight distribution of 2.25. Additionally, in the result of ¹³C-NMR (in CDCl₃) analysis, the composition of polymer was in the ratio of 37:43:20 (ratio by mole)(in order of from left of the structural formula

### Example 12

Synthesis of the Polymeric Compound of the Following Formula

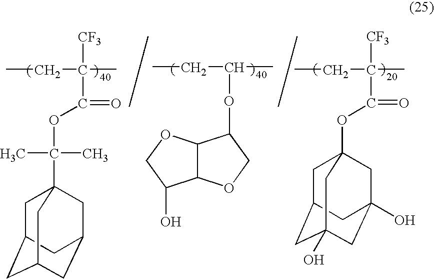

The polymeric compound was synthesized according to the same procedure as Example 3 except for using 4.70 g (16.3 mmol) of 1-[1-(2-trifluoromethyl-2-propenoyloxy)-1-methylethyl]adamantane, 2.81 g (16.3 mmol) of a mixture of 2-O-vinyl-1,4:3,6-dianhydro-D-glucitol and 5-O-vinyl-1,4:3,6-dianhydro-D-glucitol obtained in Example 2 and 2.50 g (8.2 mmol) of 1-(2-trifluoromethyl-2-propenoyloxy)-3,5-dihydroxyadamantane as monomers of raw material. After drying the recovered precipitate under reduced pressure, the amount of the obtained polymer was 8.6 g. The polymer was analyzed by GPC analysis and was found a weight average molecular weight of 8200 in terms of standard polystyrene and a molecular weight distribution of 2.19. Additionally, in the result of ³C-NMR (in CDCl₃) analysis, the composition of polymer was in the ratio of 36:43:21 (ratio by mole) (in order of from left of the structural formula).

### Example 13

Synthesis of the Polymeric Compound of the Following Formula

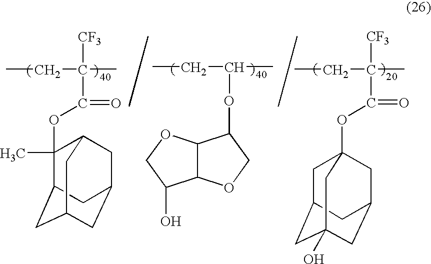

The polymeric compound was synthesized according to the same procedure as Example 3 except for using 4.76 g (16.5 mmol) of 2-(2-trifluoromethyl-2-propenoyloxy)-2-methyladamantane, 2.82 g (16.5 mmol) of a mixture of 2-O-vinyl-1,4:3,6-dianhydro-D-glucitol and 5-O-vinyl-1,4:3,6-dianhydro-D-glucitol obtained in Example 2 and 2.40 g (8.3 mmol) of 1-(2-trifluoromethyl-2-propenoyloxy)-3-hydroxyadamantane as monomers of raw material. After drying the recovered precipitate under reduced pressure, the amount of the obtained polymer was 7.8 g. The polymer was analyzed by GPC analysis and was found a weight average molecular weight of 10100 in terms of standard polystyrene and a molecular weight distribution of 2.15. Additionally, in the result of ¹³C-NMR (in CDCl₃) analysis, the composition of polymer was in the ratio of 39:42:19 (ratio by mole) (in order of from left of the structural formula

### Example 14

Synthesis of the Polymeric Compound of the Following Formula

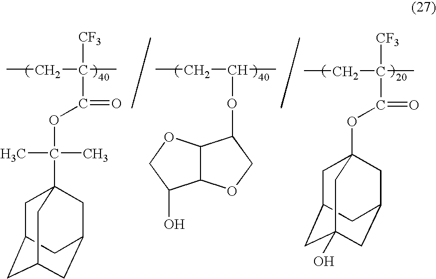

The polymeric compound was synthesized according to the same procedure as Example 3 except for using 4.99 g (15.8 mmol) of 1-[1-(2-trifluoromethyl-2-propenoyloxy)-1-methylethyl]adamantane, 2.72 g (15.8 mmol) of a mixture of 2-O-vinyl-1,4:3,6-dianhydro-D-glucitol and 5-O-vinyl-1,4:3,6-dianhydro-D-glucitol obtained in Example 2 and 2.29 g (7.9 mmol) of 1-(2-trifluoromethyl-2-propenoyloxy)-3-hydroxyadamantane as monomers of raw material. After drying the recovered precipitate under reduced pressure, the amount of the obtained polymer was 8.3 g. The polymer was analyzed by GPC analysis and was found a weight average molecular weight of 10800 in terms of standard polystyrene and a molecular weight distribution of 2.19. Additionally, in the result of ¹³C-NMR (in CDCl₃) analysis, the composition of polymer was in the ratio of 38:40:22 (ratio by mole) (in order of from left of the structural formula

Valuation Test

(Transparency of Polymer)

1 g of each of the polymers obtained in the above Examples 3 to 14 was dissolved in 10 g of propylene glycol monomethyl ether acetate (PGMEA), and was filtered through a filter of 0.2 μm to prepare a polymer solution. The polymer solution was applied onto a MgF₂ substrate by spin coating, was baked on a hot plate at a temperature of 100° C. for 120 seconds to form a polymer film 100 nm thick. Light transparency at 157 nm wavelength of the film was measured by using a vacuum-ultraviolet photometer [manufactured by NIHON BUNKO Inc., VUV-200S] and was found to be 45% or more in any case.

(Preparation of Resist and Formation of Pattern)

100 parts by weight of each of the polymers obtained in the above Example 3 to 14 and 10 parts by weight of triphenylsulfonium hexafluoroantimonate were mixed with a solvent propyleneglycol monomethyl ether acetate (PGMEA) to prepare a photoresist resin composition of 17% by weight polymer-concentration. This composition was applied onto a silicon wafer by spin coating method to form a photosensitive layer of 1.0-μm thickness. The photosensitive layer was subjected to prebaking on a hot plate at a temperature of 100° C. for 150 seconds and was exposed to light through a mask using KrF excimer laser having a wavelength of 247 nm at an irradiance of 30 mJ/cm². The exposed layer was then subjected to post-exposure baking at a temperature of 100° C. for 60 seconds; was subjected to development in a 0.3 M aqueous tetramethylammonium hydroxide solution for 60 seconds; and was rinsed with pure water to yield a pattern with a 0.20-μm line and space in any case.

### INDUSTRIAL APPLICABILITY

When photoresist resin composition containing a polymeric compound having a repeated unit corresponding to a polymerizable monomer of the present invention is used in a production of semiconductor, a micro pattern can be formed accurately.

1. A polymerizable monomer represented by the following formula (1); 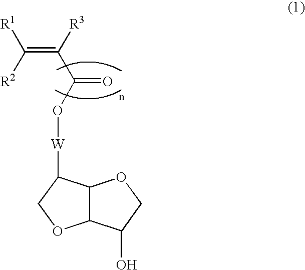
wherein R¹, R² and R³ are each a hydrogen atom, a fluorine atom, an alkyl group or a fluoroalkyl group, W is a single bond or a linkage group and n is 0 or 1, where at least one of R¹, R² and R³ is a fluorine atom or a fluoroalkyl group when n=1;
and the ring in the formula may have a substituent.

2. The polymerizable monomer according to claim 1, wherein n is 1, R¹ and R² are a hydrogen atom and R³ is a trifluoromethyl group.

3. The polymerizable monomer according to claim 1, wherein n is 0, and R¹, R² and R³ are each a hydrogen atom

4. A polymeric compound, comprising a repeated unit corresponding to the polymerizable monomer as claimed in any one of claims 1 to 3.

5. The polymeric compound according to claim 4, further comprising a repeated unit having an acid-eliminating function.

6. A resin composition for photoresist, comprising at least the polymeric compound as claimed in claim 4 and a photosensitive acid generator.

7. A process of producing a semiconductor, the method comprising the step of applying the photoresist resin composition as claimed in claim 6 onto a base or substrate to form a resist film, exposing, developing and thereby produce a pattern.
